(19) United States
(12) Patent Application Publication
(10) Pub. No.: US 2021/0137139 A1
(43) Pub. Date: May 13, 2021

(54) COMPOSITIONS FOR ANIMALS AND USES THEREOF

(71) Applicant: BASF SE, Ludwigshafen am Rhein (DE)

(72) Inventors: Peter ADER, Lampertheim (DE); Markus MATUSCHEK, Lampertheim (DE)

(21) Appl. No.: 17/255,261

(22) PCT Filed: Jun. 18, 2019
(86) PCT No.: PCT/EP2019/066045

§ 371 Date: Dec. 22, 2020

(30) Foreign Application Priority Data
Jun. 22, 2018 (EP) 18179387.8

(51) Int. Cl. A23K 20/105; A23K 50/10; A23K 50/30; A23K 50/75; A23K 50/80

(52) U.S. Cl. CPC A23K 20/105; A23K 50/10; A23K 50/80; A23K 50/75; A23K 50/30

(57) ABSTRACT

The present invention is generally concerned with the care of animals, particularly animals intended for human nutrition, for example animals used in farming and aquaculture, and is also particularly concerned with the care of pet animals. In this context, the invention relates to compositions, in particular feed compositions, veterinary formulations and antimicrobial compositions for the prevention, treatment and/or amelioration of infections by parasitic or pathogenic microorganisms. The invention also provides uses of such compositions, feeding regimes and methods for rearing or treating animals. The invention is also concerned with compositions and uses thereof for improving agronomic traits and animal health parameters.

The present invention is generally concerned with the care of animals, particularly animals intended for human nutrition, for example animals used in farming and aquaculture, and is also particularly concerned with the care of pet animals. In this context, the invention relates to compositions, in particular feed compositions, veterinary formulations and antimicrobial compositions for the prevention, treatment and/or amelioration of infections by parasitic or pathogenic microorganisms. The invention also provides uses of such compositions, feeding regimes and methods for rearing or treating animals. The invention is also concerned with compositions and uses thereof for improving agronomic traits and animal health parameters.

### BACKGROUND OF THE INVENTION

Infections by microorganisms are a major cause of profitability in land farming and aquaculture. In particular, enteric diseases caused by protozoans and/or bacteria are prevalent and both difficult to prevent and to treat. Many of such diseases are transmissible via farming products, in particular meat and eggs, but also farming refuse like manure and offal, to wild animals which serve as a reservoir for pathogens. Of particular concern are diseases transmissible to humans. Among these, for example Campylobacter has been recognized as a major cause of foodborne diarrhoeal disease worldwide.

Preventing infections of farmed animals is difficult due to the diversity of potential carriers for animal pathogens. In particular, feed and drinking water are difficult to keep pathogen free over the whole lifetime of farmed animals. But even if this route of infection could be managed, infections are still possible by contact of farmed animals with infected material produced by pathogen carrying wild animals, for example bird feces. It has thus been tried to increase the resistance of animals against pathogen infections. However, the application of antibiotics as a prophylactic measure has been widely banned to prevent accumulation of antibiotic resistance in pathogens. There is thus a need to provide effective compositions for prophylaxis against and treatment of infections in farmed animals including the promotion of resilience. Furthermore, there is a need to provide farming methods to decrease the chances of and the severity of infections of farmed animals.

In this context, EP1314358B1 discloses compositions for the treatment of enteric pathogens. The compositions comprise a medium-chain fatty acid (MCFA) component and a so-called growth-promoting component selected from organic acids, inorganic acids, animal feed antibiotics, conventional growth promoters and plant extracts. The medium-chain fatty acid component essentially consists of medium-chain fatty acids having 6-14 carbon atoms, and salts or derivatives or mixtures thereof. Particularly preferred are medium-chain saturated fatty acids, in particular caproic, caprylic, capric, lauric or myristic saturated fatty acids. The MCFA derivatives can comprise mono-, di- and triglycerides. Where the growth promoting component comprises single organic acids or a mixture of organic acids, the organic acids can be for example C1-8 carboxylic acids in substituted or unsubstituted form. The document does not disclose the presence of glycerol in any of the compositions and is likewise silent on any beneficial effect achieved by the presence of glycerol.

The present invention is, however, not limited to the prevention or treatment of animal infections by parasites. The invention is also concerned with improving sales-effective animal parameters, in particular those connected with animal growth and fattening, even in the absence of parasitic infections.

### SUMMARY OF THE INVENTION

Accordingly the present invention provides compositions comprising
formic acid or a pharmaceutically acceptable salt thereof,
glycerol and
one or more butyric acid glycerides and optionally butyric acid,
wherein
   a) formic acid, glycerol and the one or more butyric acid glycerides are present in synergistic amounts, and/or
   b) the weight ratio of glycerol to total butyric acid glycerides is from 1:10 to 10:1, and/or
   c) the weight ratio of formic acid to the total of butyric acid glycerides and glycerol is from 1:15 to 20:1, and/or
   d) the total amount of the total of formic acid, glycerol and butyric acid glycerides is from 10 wt % to 100 wt % of the total composition.

The compositions according to the present invention preferably are feed additives, are used as or are included in animal feed compositions.

Further preferably the composition according to the present invention, in particular a feed composition of the present invention, preferably is for use in the treatment or prevention of microbial infections or disorders associated with microbial infections in an animal. The invention thus preferably provides compositions for use as a medicament, preferably a veterinary medicament. The compositions according to the present invention, including for example feed additives and feed compositions, preferably are antimicrobial compositions for treating an animal.

The invention also provides feeding regimes and methods for rearing and/or fattening of animals comprising the administration of a composition of the present invention to an animal or the preparation of such compositions for animal administration. In this context, the invention also provides uses of the compositions of the present invention.

### DETAILED DESCRIPTION OF THE INVENTION

It has now been found that formic acid and/or pharmaceutically acceptable salts thereof can be synergistically combined with glycerol and glycerides of butyric acid. Such compositions provide, in an unexpected variety of animals, beneficial effects as described herein.

For the purposes of the present invention, the term “animal” refers to any non-human member of the taxonomic rank Bilateria. As will be shown in the examples hereinafter, application of a composition of the present invention to the feed of such diverse animals as for example shrimps, chickens and pigs resulted in a marked improvement of animal health parameters even under severely challenging conditions. Thus, the term “animal” in the context of the present invention excludes any member of the taxonomic kingdoms Archaea and Bacteria, and among the Eukaryota excludes for example Alveolata, Fungi and Viridiplantae. In particular, the term “animal” is according to the present invention understood to preferably indicate monogastric animals. Ruminants according to the invention are preferably included only in so far as their digestive system has not yet so fully developed that the animal can live on cellulosic plant material alone. Thus, the term “animal” according to the present invention preferably includes juvenile ruminants, in particular sucklings such as calves, lambs and kids.

Animals according to the present invention preferably are those farmed for eventual human consumption and pet animals. Preferred animals according to the present invention are:

i) aquatic animals such as finfish and shellfish, preferably Alaskan pollock, American shad, Arctic char, John Dory, anchovy, barracuda, bass, bowfin, carp, catfish, catfish, cobia, cod, croaker, cusk, eel, flounder, freshwater drum, grouper, haddock, hake, halibut, herring, hoki, kingklip, lake whitefish, lingcod, mackerel, mahi, mako shark, marlin, moi, monkfish, mullet, opah, orange roughy, perch, perch, pompano, sablefish, salmon, sea bream, skate, smelt, snapper, sturgeon, swordfish, tilapia, tilefish, tuna, turbot, wahoo, walleye, wolfish, abalone, barnacles, clams, cockles, conchs, copepods, crab, crayfish, lobster, mussel, octopus, oysters, rock snails, shrimp, squid and whelks, even more preferably
i-i) as finfish: carp, for example common carp, Asian carp, Indian carp, black carp, grass carp, silver carp and bighead carp, catfish, for example channel catfish, armoured suckermouth catfish, banjo catfish, basa, blue catfish, Corydoras, long-whiskered catfish, shark catfish, thorny catfish and walking catfish, sea bream, for example gilt-head bream, red sea bream, Saucereye porgies, scup, sheepshead and yellowfin bream, salmon, for example Atlantic salmon, chinook salmon, chum salmon, coho salmon, masu salmon, pink salmon and sockeye salmon, tilapia, for example blue tilapia, Mozambique tilapia, Nile tilapia and tilapiine cichlids;
i-ii) as shellfish: shrimp or prawn, for example Chinese white shrimp, Akiama paste shrimp, banana prawn, black tiger shrimp, fleshy prawn, freshwater shrimp, giant tiger shrimp, gulf shrimp, Northern prawn, Pacific white shrimp, pink shrimp, rock shrimp, Southern rough shrimp, whiteleg shrimp, mussel, for example Asian green mussel, Baltic mussel, blue mussel, freshwater mussel, green-lipped mussel, Mediterranean mussel, oysters, for example European flat oyster, Pacific oyster, Portuguese oyster, rock oyster, clam and scallops, for example Aequipecten opercularis, Aequipecten tehuelchus, Amusium balloti, Amusium pleuronectes, Argopecten irradians, Argopecten opercularis, Argopecten purpuratus, Argopecten ventricosus, Chlamys farreri, Chlamys islandica, Chlamys islandica, Chlamys islandica, Chlamys nobilis, Chlamys varia, Crassedoma giganteum, Euvola vogdesi, Euvola ziczac, Euvola ziczac, Flexopecten flexosus, Mizuhopecten yessoensis, Nodipecten nodosus, Nodipecten nodosus, Nodipecten subnodosus, Patinopecten caurinus, Patinopecten yessoensis, Pecten fumatus, Pecten maximus, Pecten maximus, Placopecten magellanicus, abalone, for example Haliotis asinina, Haliotis discus, Haliotis discus hannai, Haliotis diversicolor supertexta, Haliotis fulgens, Haliotis iris, Haliotis kamtschatkana, Haliotis laevigata, Haliotis laevigata, Haliotis midae, Haliotis rubra, Haliotis rubra, Haliotis rufescens and Haliotis tuberculate;
ii) land animals such as livestock, poultry, game and pets, preferably Fallow deer, reindeer, addax, alpaca, Bali cattle, camel, cattle, cows, donkey, eland, gayal, goat, Guinea pig, horse, Llama, moose, mule, muskox, pig, rabbit, oryx, sheep, Sika deer, water buffalo, yak, zebu, bison, capybara, collared peccary, deer, elk, greater cane rat, greater kudu, Thorold's deer, white-tailed deer, chicken, duck, Egyptian goose, emu, golden pheasant, goose, greater rhea, grey francolin, Guineafowl, Indian peafowl, mute swan, ostrich, partridge, pheasant, pigeon, quail, small-billed tinamou and turkey, cat, dog, rodents and companion parrot, pigeon, dove and passerine, even more preferably
ii-i) ruminants, particularly until the end of weaning: preferably camel, cattle, cow, donkey, goat, Llama, moose, reindeer and Sheep;
ii-ii) other meat producing mammals: preferably horse, pig or rabbit,
ii-iii) poultry: preferably chicken, duck, goose, turkey, emu, ostrich, pheasant and pigeon
ii-iv) pets (as far as not mentioned in another category): cat, dog, rat, mouse, hamster, guinea pig, gerbil, chinchillas, parakeet, cockatiel, pigeon, dove and canaries.

The present invention provides a composition. The composition comprises
formic acid or a pharmaceutically acceptable salt thereof,
glycerol and
one or more butyric acid glycerides and optionally butyric acid.

Within the context of the present invention, the term “butyric acid” denotes n-butyric acid.

Compositions comprising butyric acid glycerides and glycerol are known for example from EP2410871B1. This document attributes a particular effectiveness to mixtures of glycerol and butyric acid monoglycerides for improving resistance of animals against microbial pathogen infections. However, the present invention also makes use of the finding that not only butyric acid monoglycerides but also other glycerides are useful to obtain the beneficial effects provided by the present invention and described herein.

The composition of the present invention thus provides compositions comprising glycerol and one or more butyric acid glycerides selected from butyric acid 1-monoglyceride, butyric acid 2-monoglyceride, butyric acid 1,2-diglyceride, butyric acid 1,3-diglyceride and butyric acid triglyceride. Preferably, the butyric acid glycerides in a composition according to the present invention comprise

a total of butyric acid monogylcerides of 25-57 wt % relative to the total of all butyric acid glycerides and glycerol, more preferably 30-60 wt %, even more preferably 38-52 wt %, and/or comprise
a total of butyric acid digylcerides of 8-22 wt % relative to the total of all butyric acid glycerides and glycerol, more preferably 10-20 wt %, even more preferably 11-15 wt %, and/or comprise
a total of butyric acid 1-monogylceride of 25-57 wt % relative to the total of all butyric acid glycerides and glycerol, more preferably 30-60 wt %, even more preferably 34-51 wt %, and/or comprise
a total of butyric acid 2-monogylceride of 0-12 wt % relative to the total of all butyric acid glycerides and glycerol, more preferably 1-8 wt %, even more preferably 3-6 wt %, and/or comprise
a total of glycerol of 20-60 wt % relative to the total of all butyric acid glycerides and glycerol, more preferably 30-52 wt %, even more preferably 35-45 wt %, and/or comprise
a ratio of total butyric acid monoglycerides to glycerol of 10:1 to 1:10, more preferably 2:1 to 1:2, even more preferably 1.5:1 to 1:1.5, and/or comprise
a ratio of total butyric acid monoglycerides to total butyric acid diglycerides of 1:5 to 15:1, more preferably 1:1 to 10:1, even more preferably 1:2 to 1:4, and/or comprise
a ratio of total butyric acid monoglycerides to total butyric acid di- and triglycerides of 1:5 to 15:1, more preferably 1:1 to 10:1, even more preferably 1:2 to 1:4, and/or comprise
a ratio of butyric acid 1-monoglyceride to butyric acid 2-monoglyceride of 14:1 to 1:2, more preferably 11:1 to 2:1, even more preferably 9:1 to 6:1, and/or
a ratio of butyric acid 1-monoglyceride to glycerol of 10:1 to 1:10, more preferably 2:1 to 1:2, even more preferably 1.5:1 to 1:1.5.

Preferably the composition of the present invention comprises free butyric acid in an amount of 0-10 wt % relative to the total of all butyric acid glycerides, glycerol and formic acid, even more preferably 0-5 wt % and even more preferably 0-2 wt %.

The composition according to the present invention comprises formic acid. The formic acid can be in the form of a free acid and/or a pharmaceutically acceptable salt thereof. Pharmaceutically acceptable salts include those formed with inorganic cations such as, for example, sodium, potassium, lithium, ammonium, calcium or ferric hydroxides, and such organic cations as isopropylamine, trimethylamine, 2-aminoethanol, histidine, procaine and the like.

Preferably the weight ratio of formic acid and pharmaceutically acceptable salts thereof to the total of butyric acid glycerides and glycerol is from 1:15 to 20:1, even more preferably 1:10 to 15:1, even more preferably 1:5 to 10:1, even more preferably 1:1 to 5:1.

In the composition according to the present invention the total amount of the total of formic acid and pharmaceutically acceptable salts thereof, glycerol and butyric acid glycerides is from 10 wt % to 100 wt % of the total composition, more preferably 15-100%, even more preferably at least 30%.

Preferably the concentration of formic acid is 1-15 g per kg of the total composition of the present invention, preferably 3-8 g/kg, and/or the concentration of the total of glycerol and butyric acid glycerides is 0.5-30 g per kg of the total composition, preferably 0.8-20 g/kg.

The invention also provides a feed composition for feeding an animal, wherein the feed composition comprises a composition according to the present invention. Preferred animals are listed above and comprise, as indicated, finfish, shellfish, livestock, poultry, game and pets. Most preferred compositions according to the present invention are feed compositions for feeding of salmon, shrimp or prawn, calves, chicken, dogs, cats, horses, hamsters, guinea pigs and canaries.

The feed composition according to the present invention can be in liquid, semi-solid or solid form. A liquid feed composition according to the present invention comprises water and, as indicated above, a composition according to the present invention comprising formic acid or a pharmaceutically acceptable salt thereof, glycerol and one or more butyric acid glycerides and, optionally, butyric acid. In a liquid feed according to the present invention the water content preferably is 30-99.999 wt % relative to the total liquid feed. It is a particular advantage that the composition of the present invention is effective even at a very low dosage. Preferably, the total of formic acid, glycerol and butyric acid glycerides is 1 g per 1000 g total liquid feed, even more preferably 1.5-30 g per 1000 g, even more preferably 2-20 g per 1000 g, even more preferably 2-10 g per 1000 g total liquid feed. A solid or semi-solid feed composition according to the present invention comprises a solid or semi-sold carrier acceptable for feeding and, as indicated above, a composition according to the present invention comprising formic acid or a pharmaceutically acceptable salt thereof, glycerol and one or more butyric acid glycerides and, optionally, butyric acid. Preferably, the total of formic acid, glycerol and butyric acid glycerides is 1 g per 1000 g total feed (solid or semi-solid), even more preferably 1.5-30 g per 1000 g, even more preferably 2-20 g per 1000 g, even more preferably 2-10 g per 1000 g total feed.

Preferably, the feed composition according to the present invention comprises one or more additives or carriers selected from carbohydrates, lipids, proteins, amino acids, salts (other than formic acid salts) and minerals, vitamins, prebiotics and probiotics, for example fish meal, fish oil, blood meal, feather meal, poultry meal, chicken meal and/or other types of meal produced from other slaughterhouse waste, animal fat, for example poultry oil, vegetable meal, for example soy meal, lupin meal, pea meal, bean meal, rapeseed meal, camelina meal and/or sunflower meal, vegetable oil, for example rapeseed oil, soy oil, linseed oil, palm oil, lard, gluten, for example wheat gluten or corn gluten, amino acids, for example lysine, methionine, threonine, cysteine, arginine, tryptophan, vitamins, for example vitamins A, C, E, B12, D3, folic acid, D-biotin, cyanocobalamin, niacinamide, thiamine, riboflavin, pyridoxine, menadione, calciumpantothenate, choline and carotenoids, for example beta-carotene, minerals, for example phosphate, zinc, selenium and inorganic or organic salts thereof, and pre- or probiotics. The skilled person is aware of formulations to cope with the feeding requirements of different animals at different stages of development.

Within the context of the present invention the term “prebiotics” signifies a non-digestible food ingredient that beneficially affects the host by selectively stimulating the growth and/or the activity of one or a limited number of beneficial bacteria. Preferred prebiotics are plant fibre products and yeast-containing brewery by-products. The term “probiotics” as used herein signifies live microorganisms or parts thereof which, when for example ingested or locally applied in sufficient numbers, confer a demonstrable health benefits on the animal. Preferred probiotics are microorganisms of the genera Aspergillus, Bacillus, Bifidobacterium, Clostridium, Debaryomyces, Enterococcus, Hanseniaspora, Kluyveromyces, Lactobacillus, Lactococcus, Megasphaera, Pediococcus, Pichia, Propionibacterium and Saccharomyces, even more preferably any of Bacillus amyloliquefaciens, Bacillus cereus, Bacillus licheniformis, Bacillus subtilis, Bifidobacterium animalis, Bifidobacterium bifidum, Clostridium butyricum, Enterococcus faecium, Kluyveromyces lactis, Lactobacillus acidophilus, Lactobacillus reuteri, Lactobacillus rhamnosus, Lactobacillus salivarius, Lactococcus lactis, Pediococcus acidilactici and Saccharomyces cerevisiae, most preferably Bacillus sp., Lactococcus lactis, Lactobacillus sp. and Clostridium butyricum.

A solid feed composition according to the present invention can be a powder, meal or in granular form or can be extruded to form pellets. The properties of the extruded pellets, in particular shape and consistency, are influenced by the extruder's screw speed and barrel profile, by the extrusion temperature and by the composition and moisture content of the feed material being entered into the extruder. It is a particular advantage of the present invention that the efficacy (in terms of animal health beneficial properties as described herein) of the composition and feed of the present invention is not substantially affected by typical mixing and extrusion conditions. For example, to produce a solid feed, preferably a finfish or shellfish feed, a composition of the present invention comprising formic acid (or a pharmaceutically acceptable salt thereof), glycerol and one or more butyric acid glycerides is mixed with a carrier of soy and fish meal, the mixture can be preconditioned to a temperature of up to 95° C. to allow addition of water steam to achieve a moisture content of 5-30 wt % relative to the total feed composition, followed by single or twin screw extrusion into solid or porous pellets. At the extruder die head the extruded mass can have a temperature of more than 100° C., for example up to 130° C., and a more than ambient pressure. If the moisture content of the mass to be extruded is high, then immediately after leaving the extruder die head some of the moisture will evaporate and the extruded product becomes porous. The strings are cut into pellets by a rotating knife. The extruded product can be coated, for example vacuum coated, for example to further improve storage stability and/or palatability.

It is a particular advantage of the present invention that the feed (solid, semi-solid or liquid) as such is already palatable to animals despite its content of butyric acid esters such that improvements in palatability will more or less only have to account for palatability issues caused by further feed ingredients other than the composition of the present invention.

The invention also provides special feed compositions. For example, according to the invention is provided a starter feed composition comprising formic acid (preferably in the form of the Na salt thereof) in a concentration of 1-8 g/kg, and glycerol and butyric acid glyceride, wherein the ratio of formic acid to the total of glycerol and butyric acid glycerides is 1:10 to 10:1 and/or wherein the total concentration of glycerol and butyric acid glycerides is 1-8 g/kg. Such feed composition is particularly useful in a feeding regimen for feeding of poultry, most preferably for feeding chicken. For feeding chicken, the total metabolizable energy of the starter feed preferably is 3000-3200 kcal/kg feed, more preferably 3000-3100 kcal/kg feed.

Also according to the invention is provided a grower feed composition comprising formic acid (preferably in the form of the Na salt thereof) in a concentration of 1-6 g/kg, and glycerol and butyric acid glyceride, wherein the ratio of formic acid to the total of glycerol and butyric acid glycerides is 1:10 to 10:1 and/or wherein the total concentration of glycerol and butyric acid glycerides is 0.1-6 g/kg. Such feed composition is also particularly useful in a feeding regimen for feeding of poultry, most preferably for feeding chicken. For feeding chicken, the total metabolizable energy of the grower feed preferably is 3100-3200 kcal/kg feed, more preferably 3100-3180 kcal/kg feed.

And according to the invention is provided a finisher feed composition comprising formic acid (preferably in the form of the Na salt thereof) in a concentration of 1-4 g/kg, and glycerol and butyric acid glyceride, wherein the ratio of formic acid to the total of glycerol and butyric acid glycerides is 1:10 to 10:1 and/or wherein the total concentration of glycerol and butyric acid glycerides is 0.1-4 g/kg. Such feed composition is again particularly useful in a feeding regimen for feeding of poultry, most preferably for feeding chicken. For feeding chicken, the total metabolizable energy of the finisher feed preferably is 3000-3400 kcal/kg feed, more preferably 3180-3300 kcal/kg feed.

Correspondingly the invention provides a feeding regime, comprising the steps of administering to an animal

a) a starter feed composition according to the present invention for a first period of time and, thereafter, a grower feed composition according to the present invention for a second period of time,

b) a starter feed composition according to the present invention for a first period of time and, thereafter, a finisher feed composition according to the present invention for a second period of time,

c) a starter feed composition according to the present invention for a first period of time and, thereafter, a grower feed composition according to the present invention for a second period of time and, thereafter, a finisher feed composition according to the present invention for a third period of time, or

d) a grower feed composition according to the present invention for a first period of time and, thereafter, a finisher feed composition according to the present invention for a second period of time, or

e) a starter feed composition according to the present invention for a first period of time and optionally, thereafter, a probiotic feed.

In preferred feeding regimes for poultry, in particular for chicken, a starter composition as indicated above is administered for a (first) period of 21 days after hatching; feeding is thereafter continued by administration of a grower composition as indicated above for the period until and including day 35 after hatching (i.e. second period: days 22-35). The chicken can then be slaughtered, particularly for the production of male chicken. For any remaining animals a finisher composition as indicated above can be fed after day 35 until day harvesting of the chicken, typically at day 42.

The feeding regimes according to the present invention are particularly suitable for reacting to any development of health issues during the lifetime of the animals; the regimes are also beneficially adapted to the different nutritional requirements at each respective growth stage. For example, the metabolizable energy of a starter feed (expressed as kcal/kg feed) can be lower than that of a grower feed, whose metabolizable energy in turn can be lower than that of a finisher feed.

It is of particular advantage that the present invention provides a veterinary formulation comprising an effective amount of formic acid or a pharmaceutically salt thereof, glycerol and one or more butyric acid glycerides and optionally butyric acid. In particular, a veterinary formulation according to the present invention can comprise or consist of a composition according to the present invention, for example in the form of a feed composition as described herein. A composition according to the present invention for use as a medicament, preferably a veterinary medicament, is thus provided.

In particular, the invention provides a composition according to the invention for use in the treatment or prevention of microbial infections or disorders associated with microbial infections in an animal. Preferred animals to be treated are described above.

The term “microbial infection” in the context of the present invention means any form of colonization or other presence on or in an animal, for example on or in skin, teeth, flesh, bone, blood or gut content. A microbe implicated in an infection according to the present invention can be any microorganism, in particular a Gram-negative or Gram-positive microorganism or a member of phylum Apicomplexa. Within the context of the present invention, a microorganism capable of infecting an animal as listed above and eliciting symptoms of illness is also called a “parasite” or “pathogen.

The invention in particular provides compositions, including veterinary compositions, for the prevention or treatment of alveolate infections, preferably by a microorganism of class Aconoidasida or Conoidasida, even more preferably of order Haemosporida or Piroplasmida or of subclass Coccidia or Gregarinasina, and even more preferably of order Agamococcidiorida or Eucoccidiorida or of order Archigregarinorida, Eugregarinorida, Nematopsis or Neogregarinorida. Preferably the composition, veterinary composition or feed is used or arranged to prevent, treat or ameliorate symptoms of infections by a microorganism of family Cryptosporidiidae, Sarcocystidae or Eimeriidae, even more preferably of genus Cryptosporidium, Besnoitia, Cystoisospora, Frenkelia, Hammondia, Hyaloklossia, Neospora, Nephroisospora, Sarcocystis, Toxoplasma, Acroeimeria, Atoxoplasma, Caryospora, Choleoeimeria, Cyclospora, Eimeria, Goussia, Isospora or Margolisiella, even more preferably of genus Cryptosporidium, Cyclospora or Eimeria.

The invention in particular provides compositions, including veterinary compositions, for the prevention or treatment of (generally Gram-negative) microogranisms of order Enterobacterales, Vibrionales, Desulfovibrionales, Pseudomonadales, Burkholderiales and order Campylobacterales, even more preferably of any family selected from Budviciaceae, Enterobacteriaceae, Erwiniaceae, Hafniaceae, Morganellaceae, Pectobacteriaceae, Thorselliaceae, Yersiniaceae, Vibrionaceae, Desulfohalobiaceae, Desulfomicrobiaceae, Desulfonatronaceae, Desulfovibrionaceae, Moraxellaceae, Pseudomonadaceae, Ventosimonadaceae, Alcaligenaceae, Burkholderiaceae, Comamonadaceae, Oxalobacteraceae, Sutterellaceae, Campylobacteraceae, Helicobacteraceae, and Hydrogenimonaceae, even more preferably of a genus selected from Budvicia, Leminorella, Pragia, Atlantibacter, Biostraticola, Buttiauxella, Cedecea, Citrobacter, Cronobacter, Enterobacillus, Enterobacter, Escherichia, Franconibacter, Gibbsiella, Izhakiella, Klebsiella, Kluyvera, Kosakonia, Leclercia, Lelliottia, Limnobaculum, Mangrovibacter, Metakosakonia, Pluralibacter, Pseudescherichia, Pseudocitrobacter, Raoultella, Rosenbergiella, Salmonella, Shigella, Shimwellia, Siccibacter, Trabulsiella, Yokenella, Buchnera, Erwinia, Pantoea, Phaseolibacter, Tatumella, Wigglesworthia, Edwardsiella, Hafnia, Obesumbacterium, Arsenophonus, Cosenzaea, Moellerella, Morganella, Photorhabdus, Proteus, Providencia, Xenorhabdus, Brenneria, Dickeya, Lonsdalea, Pectobacterium, Sodalis, Coetzeea, Thorsellia, Chania, Ewingella, Nissabacter, Rahnella, Rouxiella, Samsonia, Serratia, Yersinia, Aliivibrio, Allomonas, Catenococcus, Echinimonas, Enterovibrio, Grimontia, Paraphotobacterium, Photobacterium, Photococcus, Salinivibrio, Thaumasiovibrio, Vibrio, Desulfohalobium, Desulfohalophilus, Desulfonatronospira, Desulfonatronovibrio, Desulfonauticus, Desulfothermus, Desulfovermiculus, Desulfomicrobium, Desulfoplanes, Desulfonatronum, Bilophila, Desulfobaculum, Desulfocurvus, Desulfovibrio, Halodesulfovibrio, Lawsonia, Mailhella, Pseudodesulfovibrio, Acinetobacter, Alkanindiges, Cavicella, Faucicola, Fluviicoccus, Moraxella, Paraperlucidibaca, Perlucidibaca, Psychrobacter, Azotobacter group, Mesophilobacter, Oblitimonas, Permianibacter, Pseudomonas, Rugamonas, Thiopseudomonas, Ventosimonas, Achromobacter, Advenella, Alcaligenes, Ampullimonas, Azohydromonas, Basilea, Bordetella, Brackiella, Caenimicrobium, Candidimonas, Castellaniella, Derxia, Eoetvoesia, Kerstersia, Oligella, Orrella, Paenalcaligenes, Paracandidimonas, Paralcaligenes, Parapusillimonas, Parvibium, Pelistega, Pigmentiphaga, Pusillimonas, Saccharedens, Taylorella, Verticiella, Burkholderia, Caballeronia, Chitinimonas, Cupriavidus, Formosimonas, Hydromonas, Lautropia, Limnobacter, Mycoavidus, Pandoraea, Paraburkholderia, Paucimonas, Polynucleobacter, Quisquiliibacterium, Ralstonia, Robbsia, Thermothrix, Acidovorax, Alicycliphilus, Brachymonas, Caenimonas, Caldimonas, Comamonas, Corticibacter, Curvibacter, Delftia, Diaphorobacter, Doohwaniella, Extensimonas, Giesbergeria, Hydrogenophaga, Hylemonella, Kinneretia, Lampropedia, Limnohabitans, Macromonas, Malikia, Melaminivora, Oryzisolibacter, Ottowia, Pelomonas, Polaromonas, Pseudacidovorax, Pseudorhodoferax, Ramlibacter, Rhodoferax, Schlegelella, Simplicispira, Tibeticola, Variovorax, Verminephrobacter, Xenophilus, Zhizhongheella, Actimicrobium, Candidatus Zinderia, Collimonas, Duganella, Glaciimonas, Herbaspirillum, Herminiimonas, Janthinobacterium, Massilia, Noviherbaspirillum, Oxalicibacterium, Oxalobacter, Paraherbaspirillum, Pseudoduganella, Telluria, Undibacterium, Dakarella, Duodenibacillus, Parasutterella, Sutterella, Turicimonas, Arcobacter, Campylobacter, Sulfurospirillum, Flexispira, Helicobacter, Sulfuricurvum, Sulfurimonas, Thiovulum, Wolinella, Hydrogenimonas, Nitratifractor and Thiofractor, even more preferably from a genus selected from Escherichia, Salmonella, Yersinia, Vibrio, Lawsonia, Acinetobacter, Pseudomonas, Burkholderia, Campylobacter and Helicobacter and most preferably from a genus selected from Salmonella, Campylobacter and Vibrio.

And the invention provides compositions, including veterinary compositions, for the prevention or treatment of (generally Gram-positive) microogranisms of order Clostridiales, Bacillales and Lactobacillales, more preferably of a taxonomic family selected from Caldicoprobacteraceae, Catabacteriaceae, Christensenellaceae, Clostridiaceae, Defluviitaleaceae, Eubacteriaceae, Gracilibacteraceae, Heliobacteriaceae, Lachnospiraceae, Oscillospiraceae, Peptococcaceae, Peptostreptococcaceae, Proteinivoraceae, Ruminococcaceae, Symbiobacteriaceae, Syntrophomonadaceae, Alicyclobacillaceae, Bacillaceae, Listeriaceae, Paenibacillaceae, Pasteuriaceae, Planococcaceae, Sporolactobacillaceae, Staphylococcaceae, Thermoactinomycetaceae, Aerococcaceae, Carnobacteriaceae, Enterococcaceae, Lactobacillaceae, Leuconostocaceae, Streptococcaceae, even more preferably of a genus selected from Caldicoprobacter, Catabacter, Beduinibacterium, Christensenella, Alkaliphilus, Anaeromicrobium, Anaerosolibacter, Anoxynatronum, Beduini, Brassicibacter, Butyricicoccus, Caldanaerocella, Caldisalinibacter, Caloramator, Caloranaerobacter, Caminicella, Cellulosibacter, Clostridiisalibacter, Clostridium, Crassaminicella, Desnuesiella, Falcatimonas, Fervidicella, Fonticella, Geosporobacter, Haloimpatiens, Hathewaya, Hungatella, lnediibacterium, Keratinibaculum, Khelaifiella, Lactonifactor, Linmingia, Lutispora, Maledivibacter, Marinisporobacter, Massilioclostridium, Mordavella, Natronincola, Oceanirhabdus, Oxobacter, Paramaledivibacter, Proteiniclasticum, Salimesophilobacter, Sarcina, Senegalia, Serpentinicella, Sporosalibacterium, Thermobrachium, Thermohalobacter, Thermotalea, Tindallia, Wukongibacter, Youngiibacter, Defluviitalea, Vallitalea, Acetobacterium, Alkalibacter, Alkalibaculum, Aminicella, Anaerofustis, Eubacterium, Garciella, Intestinibacillus, Irregularibacter, Pseudoramibacter, Rhabdanaerobium, Gracilibacter, Heliobacillus, Heliobacterium, Heliophilum, Heliorestis, Abyssivirga, Acetatifactor, Acetitomaculum, Agathobacter, Anaerobium, Anaerocolumna, Anaerosporobacter, Anaerostipes, Anaerotaenia, Anaerotignum, Bariatricus, Blautia, Butyrivibrio, Caecibacterium, Catonella, Cellulosilyticum, Coprococcus, Cuneatibacter, Dorea, Eisenbergiella, Extibacter, Faecalicatena, Faecalimonas, Frisingicoccus, Fusicatenibacter, Glucerabacter, Herbinix, Hespellia, Johnsonella, Kineothrix, Lachnoanaerobaculum, Lachnobacterium, Lachnoclostridium, Lachnospira, Lachnotalea, Marvinbryantia, Merdimonas, Mobilisporobacter, Mobilitalea, Moryella, Muricomes, Murimonas, Niameybacter, Oribacterium, Parasporobacterium, Pseudobutyrivibrio, Robinsoniella, Roseburia, Sellimonas, Shuttleworthia, Sporobacterium, Stomatobaculum, Syntrophococcus, Tyzzerella, Marseillibacter, Oscillibacter, Cryptanaerobacter, Dehalobacter, Dehalobacterium, Desulfitibacter, Desulfitispora, Desulfitobacteriurn, Desulfocucumis, Desulfonispora, Desulfosporosinus, Desulfotomaculum, Desulfurispora, Pelotomaculum, Peptococcus, Sporotomaculum, Syntrophobotulus, Thermincola, Acetoanaerobium, Asaccharospora, Clostridioides, Criibacterium, Filifactor, Intestinibacter, Paeniclostridium, Paraclostridium, Peptoanaerobacter, Peptoclostridium, Peptostreptococcus, Proteocatella, Romboutsia, Sporacetigenium, Tepidibacter, Terrisporobacter, Anaerobranca, Proteinivorax, Acetanaerobacterium, Acetivibrio, Acutalibacter, Agathobaculum, Anaerobacterium, Anaerofilum, Anaeromassilibacillus, Anaerotruncus, Angelakisella, Bittarella, Caproiciproducens, Drancourtella, Ercella, Ethanoligenens, Faecalibacterium, Fastidiosipila, Fournierella, Gemmiger, Gorbachella, Harryflintia, Herbivorax, Hydrogenoanaerobacterium, Mageeibacillus, Marasmitruncus, Massilimaliae, Negativibacillus, Neglecta, Neobitarella, Oscillospira, Paludicola, Papillibacter, Phocea, Provencibacterium, Pseudobacteroides, Pygmaiobacter, Ruminiclostridium, Ruminococcus, Ruthenibacterium, Saccharofermentans, Sporobacter, Subdoligranulum, Caldinitratiruptor, Symbiobacterium, Dethiobacter, Pelospora, Syntrophomonas, Syntrophothermus, Thermohydrogenium, Thermosyntropha, Alicyclobacillus, Effusibacillus, Kyrpidia, Tumebacillus, Aeribacillus, Alkalibacillus, Alkalicoccus, Allobacillus, Alteribacillus, Amphibacillus, Amylobacillus, Anaerobacillus, Anoxybacillus, Aquibacillus, Aquisalibacillus, Aureibacillus, Bacillus, Caldalkalibacillus, Caldibacillus, Calditerricola, Cerasibacillus, Compostibacillus, Desertibacillus, Domibacillus, Edaphobacillus, Falsibacillus, Fermentibacillus, Fictibacillus, Filobacillus, Geobacillus, Gracilibacillus, Halalkalibacillus, Halobacillus, Halolactibacillus, Hydrogenibacillus, Lentibacillus, Lysinibacillus, Marinococcus, Massilibacterium, Melghiribacillus, Microaerobacter, Natribacillus, Natronobacillus, Numidum, Oceanobacillus, Ornithinibacillus, Parageobacillus, Paraliobacillus, Paralkalibacillus, Paucisalibacillus, Pelagirhabdus, Piscibacillus, Polygonibacillus, Pontibacillus, Pseudogracilibacillus, Psychrobacillus, Quasibacillus, Rubeoparvulum, Saccharococcus, Salibacterium, Salimicrobium, Salinibacillus, Salipaludibacillus, Salirhabdus, Salisediminibacterium, Saliterribacillus, Salsuginibacillus, Sediminibacillus, Sinibacillus, Streptohalobacillus, Swionibacillus, Tenuibacillus, Tepidibacillus, Terribacillus, Terrilactibacillus, Texcoconibacillus, Thalassobacillus, Thermolongibacillus, Virgibacillus, Vulcanibacillus, Brochothrix, Listeria, Ammoniibacillus, Aneurinibacillus, Brevibacillus, Chengkuizengella, Cohnella, Fontibacillus, Gorillibacterium, Marinicrinis, Paenibacillus, Saccharibacillus, Thermobacillus, Xylanibacillus, Pasteuria, Bhargavaea, Caryophanon, Chryseomicrobium, Crocinobacterium, Filibacter, Jeotgalibacillus, Kurthia, Paenisporosarcina, Planococcus, Planomicrobium, Rummeliibacillus, Savagea, Solibacillus, Sporosarcina, Tetzosporium, Ureibacillus, Viridibacillus, Caenibacillus, Camelliibacillus, Pullulanibacillus, Scopulibacillus, Sinobaca, Sporolactobacillus, Tuberibacillus, Abyssicoccus, Aliicoccus, Auricoccus, Corticicoccus, Jeotgalicoccus, Macrococcus, Nosocomiicoccus, Salinicoccus, Staphylococcus, Baia, Croceifilum, Desmospora, Geothermomicrobium, Hazenella, Kroppenstedtia, Laceyella, Lihuaxuella, Marininema, Marinithermofilum, Mechercharimyces, Melghirimyces, Novibacillus, Paludifilum, Planifilum, Polycladomyces, Risungbinella, Salinithrix, Seinonella, Shimazuella, Thermoactinomyces, Thermoflavimicrobium, Abiotrophia, Aerococcus, Dolosicoccus, Eremococcus, Facklamia, Globicatella, Ignavigranum, Agitococcus, Alkalibacterium, Allofustis, Alloiococcus, Atopobacter, Atopococcus, Atopostipes, Carnobacterium, Desemzia, Dolosigranulum, Granulicatella, Isobaculum, Jeotgalibaca, Lacticigenium, Marinilactibacillus, Pisciglobus, Trichococcus, Bavariicoccus, Catellicoccus, Enterococcus, Melissococcus, Pilibacter, Tetragenococcus, Vagococcus, Lactobacillus, Pediococcus, Sharpea, Convivina, Fructobacillus, Leuconostoc, Oenococcus, Weissella, Floricoccus, Lactococcus (lactic streptococci), Lactovum, Okadaella, Streptococcus, and most preferably of a genus selected from Clostridium (most preferably Clostridium perfringens), Bacillus, Listeria, Staphylococcus, Enterococcus and Streptococcus.

In view of the above microorganisms it is a particular advantage of the present invention that the compositions including feeds, antimicrobial and veterinary compositions have gut health improving properties. In particular, they are useful for the prevention, amelioration, treatment or cure of enteritis and/or coccidiosis in animals.

The invention thus provides a composition for use in animals for reducing, compared to an untreated control, (i) the small intestine lesion score, (ii) the small intestine coccidial oocyst count, (iii) in caecum, small intestine, breast meat, wing meat and/or neck skin any of: the incidence of a microorganism as indicated above, the titre of a microorganism as indicated above, and the APC.

The reduction of small intestinal lesion score and/or coccidial oocyst counts are particularly advantageous for poultry farming. The lesion score is determined according to the publication “Lesion scoring techniques in battery and floor pen experiments with chickens”, Exp. Parasitol. 28:30-36 on a scale from 0—no lesions to 4—most severe lesions. It is a particular advantage of the present invention that the compositions provided herein, including feeds, antimicrobial and veterinary compositions, can reduce the lesion score by 1 order of magnitude and/or can reduce the lesion score to 1 or below. Surprisingly, the compositions provided herein, including feeds, antimicrobial and veterinary compositions, can reduce the lesion score to or below the order obtainable by a combined coccidiostat and antibiotic treatment and/or can reduce the lesion score to such level that no statistically significant difference to a healthy population of the respective animals is observed with a significance level p<0.05. The reduction in lesion score is preferably obtained for poultry within 42 days post infection, even more preferably with 22 days post infection, and is thus achieved surprisingly fast given the absence of coccidiostats and antibiotics.

The small intestine coccidial oocyst count according to the invention is determined by counting coccidial oocysts from intestine samples. It is a particular advantage of the present invention that the compositions provided herein, including feeds, antimicrobial and veterinary compositions, can reduce the small intestine coccidial oocyst count by a factor of at least 1.5 within 42 days post infection, even more preferably within 22 days post infection.

According to another advantage of the present invention, the compositions provided herein, including feeds, antimicrobial and veterinary compositions, can reduce, in caecum, small intestine, breast meat, wing meat and/or neck skin, one or more of: the incidence of a microorganism as indicated above, the titre of a microorganism as indicated above, and the aerobic plate count (“APC”) or colony forming units (“cfu”) on growth media suitable for said microorganism pathogen under aerobic or anaerobic conditions. Preferably the compositions provided herein, including feeds, antimicrobial and veterinary compositions, can reduce, in caecum, small intestine, breast meat, wing meat and/or neck skin, the incidence or titre of alveolates, Gram-negative and/or Gram-positive pathogens, most preferably of any of the genera Escherichia, Salmonella, Campylobacter, Vibrio, Clostridium, Bacillus, Listeria, Staphylococcus, Enterococcus and Streptococcus. Within the context of the present invention, the term “incidence” means the fraction of infected animals relative to the total population size, the term “titre” means the count of the respective pathogen in the respective tissue or intestinal material.

The invention is, however, not limited to the prevention, amelioration, reduction or cure of pathogen infections. Advantageously the invention provides compositions, including feeds, antimicrobial and veterinary compositions, which, when fed to an animal, result in a particular improvement in any parameter selected from the group consisting of body weight gain, body weight coefficient of variation, feed conversion ratio, survivor percentage, feed intake, birth rate, egg quality and hatchability.

The invention is hereinafter further described by way of examples. The skilled person understands that the invention is not limited to the contents of the examples; in particular, the claims shall not be restricted to the scope of any particular example unless the claims comprise all features of said example.

### EXAMPLES

### Example 1: Poultry with Mild and Severe Challenge by Coccidia and Campylobacter

A total of 4,680 birds of a chick strain are housed at hatch (one day of age, or Trial Day 0) to begin the test feeding period and fed the following groups:

| Treatment | | | |
|---|---|---|---|
| Number | Starter | Grower | Finisher |
| T1 | 1-PC | 1-PC | 1-PC |
| T2 | 2-NC (with challenge) | 2-NC (with challenge) | 2-NC (with challenge) |
| T3 | 3-NC + 1.5 kg/MT | 3-NC + 1.5 kg/MT | 3-NC + 1.5 kg/MT |
| | Monobutyrate | Monobutyrate | Monobutyrate |
| T4 | 4-NC + 2.5 kg/MT | 4-NC + 2.5 kg/MT | 4-NC + 2.5 kg/MT |
| | Monobutyrate | Monobutyrate | MONOBUTYRATE |
| T5 | 5-NC + 4.0 kg/MT | 5-NC + 4.0 kg./MT − | 5-NC + 4.0 kg/MT |
| | Monobutyrate | Monobutyrate | MONOBUTYRATE |
| T6 | 6-NC + 4 0 kg/MT | 6-NC + 2.5 kg/MT | 6-NC + 2.5 kg/MT |
| | Monobutyrate | MONOBUTYRATE | MONOBUTYRATE |
| T7 | 7-NC + 2.5 kg/MT | 7-NC 1.5 kg/MT | 7-NC 0.75 kg/MT |
| | Monobutyrate in | Monobutyrate in | MONOBUTYRATE in |
| | STARTER | GROWER | FINISHER |
| T8 | 8-NC + 8 kg/MT | 8-NC + 8 kg/MT | 8-NC + 8 kg/MT |
| | Amasil NA | Amasil NA | Amasil NA |
| T9 | 9-NC + 2.5 kg/MT | 9-NC + 2.5 kg/MT | 9-NC + 2.5 kg/MT |
| | Monobutyrate + | MONOBUTYRATE + | Monobutyrate + |
| | 4 kg/MT | 4 kg/MT | 4 kg/MT |
| | Amasil NA | Amasil NA | Amasil NA |
| T10 | 10-NC standard | 10-NC standard | 10-NC standard |
| | coccidiostat and | coccidiostat and | coccidiostat and |
| | antibiotic program | antibiotic program | antibiotic program |

PC: untreated and unchallenged control; NC: untreated but challenged control; MT: metric ton;
Monobutyrate: a composition comprising 37.5-41 wt % butyric acid 1-monoglyceride, 4.5-5.5 wt % butyric acid 2-monoglyceride, 8.5-9 wt % butyric acid 1,3-diglyceride, 4.8-5.2 wt % butyric acid 1,2-diglyceride, 1.0-1.3 wt % butyric acid triglyceride, 39.5-43.5 wt % glycerol, 0-1 wt % free butyric acid;
Amasil NA: formic acid (61 wt %), Na formate (20.5 wt %) in water; standard coccidiostat and antibiotic program: avilamycin, monensin sodium and bacitracin methylene disalicylate.

Thus, for example in treatment T9 chicken are treated as in the negative control treatment T2, i.e. they receive a challenging exposure to coccidia and Clostridium perfringens according to the mild or severe challenge experiment as described below, whereas they are fed with the respective starter, grower and finisher feed of trial T2 augmented by the addition of Monobutyrate and Amasil as indicated in the table.

The composition of the respective starter, grower and finisher feed are:

| Starter | T1 | T2 | T3 | T4 | T5 | T6 | T7 | T8 | T9 | T10 |
|---|---|---|---|---|---|---|---|---|---|---|
| Product | % added | % added | % added | % added | % added | % added | % added | % added | % added | % added |
| Amasil | 0.00 | 0.00 | 0.00 | 0.00 | 0.00 | 0.00 | 0.00 | 0.80 | 0.40 | 0.00 |
| Monobutyrin | 0.00 | 0.00 | 0.15 | 0.25 | 0.40 | 0.40 | 0.25 | 0.00 | 0.25 | 0.00 |
| Salt | 0.12 | 0.12 | 0.12 | 0.12 | 0.12 | 0.12 | 0.12 | 0.00 | 0.07 | 0.12 |
| Corn | 0.95 | 0.95 | 1.05 | 1.10 | 1.18 | 1.18 | 1.10 | 0.00 | 0.60 | 0.95 |
| Oil | 0.63 | 0.63 | 0.38 | 0.23 | 0.00 | 0.00 | 0.23 | 0.90 | 0.38 | 0.63 |
| Total (%) | 1.70 | 1.70 | 1.70 | 1.70 | 1.70 | 1.70 | 1.70 | 1.70 | 1.70 | 1.70 |

| Grower | T1 | T2 | T3 | T4 | T5 | T6 | T7 | T8 | T9 | T10 |
|---|---|---|---|---|---|---|---|---|---|---|
| Product | % added | % added | % added | % added | % added | % added | % added | % added | % added | % added |
| Amasil | 0.00 | 0.00 | 0.00 | 0.00 | 0.00 | 0.00 | 0.00 | 0.80 | 0.40 | 0.00 |
| Monobutyrin | 0.00 | 0.00 | 0.15 | 0.25 | 0.40 | 0.25 | 0.15 | 0.00 | 0.25 | 0.00 |
| Salt | 0.12 | 0.12 | 0.12 | 0.12 | 0.12 | 0.12 | 0.12 | 0.00 | 0.07 | 0.12 |
| Corn | 0.95 | 0.95 | 1.05 | 1.10 | 1.18 | 1.10 | 1.05 | 0.00 | 0.60 | 0.95 |
| Oil | 0.63 | 0.63 | 0.38 | 0.23 | 0.00 | 0.23 | 0.38 | 0.90 | 0.38 | 0.63 |
| Total (%) | 1.70 | 1.70 | 1.70 | 1.70 | 1.70 | 1.70 | 1.70 | 1.70 | 1.70 | 1.70 |

| Finisher | T1 | T2 | T3 | T4 | T5 | T6 | T7 | T8 | T9 | T10 |
|---|---|---|---|---|---|---|---|---|---|---|
| Product | % added | % added | % added | % added | % added | % added | % added | % added | % added | % added |
| Amasil | 0.00 | 0.00 | 0.00 | 0.00 | 0.00 | 0.00 | 0.00 | 0.80 | 0.40 | 0.00 |
| Monobutyrin | 0.00 | 0.00 | 0.15 | 0.25 | 0.40 | 0.15 | 0.075 | 0.00 | 0.25 | 0.00 |
| Salt | 0.12 | 0.12 | 0.12 | 0.12 | 0.12 | 0.12 | 0.12 | 0.00 | 0.07 | 0.12 |
| Corn | 0.95 | 0.95 | 1.05 | 1.10 | 1.18 | 1.05 | 1.00 | 0.00 | 0.60 | 0.95 |
| Oil | 0.63 | 0.63 | 0.38 | 0.23 | 0.00 | 0.38 | 0.50 | 0.90 | 0.38 | 0.63 |
| Total (%) | 1.70 | 1.70 | 1.70 | 1.70 | 1.70 | 1.70 | 1.70 | 1.70 | 1.70 | 1.70 |

All rations are isocaloric and isosodium. A basal diet consists of the recommended energy levels minus the highest energy treatment level of Monobutyrate and Amasil NA, and minus the highest sodium treatment level of Amasil NA, with room remaining for the addition of corn, oil, and sodium as necessary to each of the treatments. A randomized block design is used to allocate chicks to pens and pens to treatment groups. Broilers are randomly distributed separately into blocks. All treatment means are separated using Least Significant Difference. Prior to initiation of treatment, the groups are assessed to assure equal distribution based on weight. The mean body weights of the treatment groups are compared to the control group. Groups with mean weights greater or less than one standard deviation of the mean control group undergo another randomization to assure equal distribution of weight.

The chicken are grown in litter floor pens, housed in a room of wood/cinder block structure with metal roof and low ceiling insulated to R value of 12 for the roof and 12 for the side walls. The house has a cross-house ventilation system and ceiling fans evenly spaced. Warm room brooding is provided with forced air heaters (Trial days 0 to 42 days). Heat source include force-air heat. Broilers housed in litter floor pens measuring 1.5 m×3 m. Each pen serves as an experimental unit, a total of 90 pens are used for test purposes. Pens, feeders and waterers are sanitized prior to bird placement on Trial Day 0.

Chicks are observed at least two times daily beginning on trial day 0 to determine mortality or the onset, severity, and duration of any behavioral changes or evidence of toxicity including fecal material condition, presence of diarrhea, nervousness, accessibility to water and feed, general bird appearance, and any adverse conditions which should affect performance. Feather sex is used to determine sex and broilers are placed in the pen using all broilers. Unusual observations are recorded and confirmed by a veterinarian. All management procedures are consistent with commercial poultry practices. Health exams are performed at 21 and 42 days of age:

Body weights are taken by weighing individual chicks in a pen and be recorded for Trial Days 0, 14, 21, 35 and 42. Body weight gain is calculated by determining actual body weight gain (ending minus beginning weights) during the periods of trial days 0-14, 0-21, 0-35, 0-42, 15-21, 22-35, and 36-42. Body weights are also taken on both moribund birds and test animals that are found dead during the study. Body weight uniformity (CV or Coefficient of Variation) is determined on Trial Days 14, 21, 35 and 42.

Feed weigh-backs are taken on Trial Days 14, 21, 35 and 42. Food consumption is evaluated for each pen on trial days 0-14, 0-21, 0-35, 0-42, 15-21, 22-35, and 36-42. A separate container (feed trough) is assigned for each pen. The initial tare weight for each feed barrel is recorded on Trial Day 0. Feed is added and the weight recorded. Adding feed: Prior to adding feed, the feed barrel is weighed and the weight recorded (Weight out). Feed out means feed that is removed and taken out of the calculations. New feed is added and the weight recorded (Weight in). Feed spilled should be weighed (weights recorded on appropriate forms) and is discarded (i.e. is not used for further consumption). Feed Conversion is determined on Trial Days 0-14, 0-21, 0-35, 0-42, 15-21, 22-35, and 36-42. Mortality is taken daily and reported as percentage per time period for Trial Days 0-14, 0-21, 0-35, 0-42, 15-21, 22-35, and 36-42. Intestinal bacteria incidence and titre is determined at both 21 (3 males and 3 females in each experimental unit) and 42 days of age (10 birds per experimental unit). Intestinal bacteria evaluations include: Caecal Campylobacter log 10 levels, Caecal Salmonella spp. incidence, Caecal Clostridium perfringens log 10 levels, Caecal Campylobacter log 10 levels, Caecal E. coli log 10 levels, Caecal Aerobic Plate Count log 10 levels, Small Intestine Campylobacter log 10 levels, Small Intestine Salmonella spp. incidence, Small Intestine Clostridium perfringens log 10 levels, Small Intestine Campylobacter log 10 levels, Small Intestine E. coli log 10 levels, and Small Intestine Aerobic Plate Count log 10 levels. Fecal Coccidial Oocyst Counts are performed on both 21 (3 males and 3 females in each experimental unit) and 42 days of age (10 birds per experimental unit).

At 43-45 days of age, 10 birds (5 male and 5 female) are processed from each replicate, from 9 replicates, to determine the microorganism counts (Clostridium perfringens and Campylobacter) on breast, skin in neck and skin below the wing area. Salmonella spp. incidence and count are determined on the same parts.

All birds sacrificed on trial Day 42. Complete necropsy examinations are performed on all chicks found dead or moribund during the study. All animals placed on study are gross necropsied and observations are recorded.

Data generated during the study are subjected to the following statistical tests: For all parameters, the multi-factorial procedure is used to compare means of treatment groups, using ANOVA (Analysis of Variance). Means are further separated using Least Significant Difference.

Significant differences reported at the p<0.05 level are indicated in the figures. Data include: Body weight, Food consumption, and Mortality.

Challenges:

MILD: On day 5 post-hatch for all treatments with the exception of Treatment 1 each pen is top-dressed with approximately 2.5 million total oocysts of Eimeria acervulina and Eimeria maxima (or 50,000 per bird) and Clostridium perfringens (inoculated via used litter) to generate 5-8% mortality

SEVERE: On day 5 post-hatch for all treatments with the exception of Treatment 1 each pen is top-dressed with approximately 5 million total oocysts of Eimeria acervulina and Eimeria maxima (or 100,000 per bird) and Clostridium perfringens (inoculated via used litter) to generate 8-10% mortality.

| Days 0-14 | T1 | T2 | T3 | T4 | T5 |
|---|---|---|---|---|---|
| Average Body Wt. (g) Day 0 | 41.93 | 41.79 | 42.01 | 42.18 | 41.76 |
| Significance (P < 0.05) | a | a | a | a | a |
| Average Body Wt. (g) Day 14 | 388.32 | 372.85 | 375.02 | 378.74 | 382.06 |
| Significance (P < 0.05) | a | d | d | cd | abc |
| Feed Conversion Corrected Day 0-14 | 1.04 | 1.07 | 1.06 | 1.06 | 1.05 |
| Significance (P < 0.05) | a | c | bc | abc | abc |
| Mortality % Day 0-14 | 1.07 | 4.27 | 2.99 | 2.56 | 1.92 |
| Significance (P < 0.05) | a | c | bc | abc | ab |
| Average Body Wt. Gain (g) Day 0-14 | 346.39 | 331.06 | 333.00 | 336.56 | 340.29 |
| Significance (P < 0.05) | a | c | c | bc | ab |
| Body Weight Coefficient of Variation (Day 14) | 10.59 | 11.08 | 11.02 | 10.70 | 10.53 |
| Significance (P < 0.05) | abc | c | bc | abc | abc |
| Feed Intake (g) Day 0-14 | 18541 | 18004 | 18043 | 18239 | 18346 |
| Significance (P < 0.05) | a | a | a | a | a |
| Days 0-14 | T6 | T7 | T8 | T9 | T10 |
| Average Body Wt. (g) Day 0 | 41.80 | 41.81 | 41.81 | 41.88 | 42.17 |
| Significance (P < 0.05) | a | a | a | a | a |
| Average Body Wt. (g) Day 14 | 381.87 | 378.02 | 385.42 | 386.26 | 383.54 |
| Significance (P < 0.05) | bc | cd | ab | ab | abc |
| Feed Conversion Corrected Day 0-14 | 1.05 | 1.06 | 1.04 | 1.04 | 1.05 |
| Significance (P < 0.05) | abc | abc | ab | ab | ab |
| Mortality % Day 0-14 | 1.92 | 2.35 | 1.28 | 1.07 | 1.71 |
| Significance (P < 0.05) | ab | ab | ab | a | ab |
| Average Body Wt. Gain (g) Day 0-14 | 340.07 | 336.20 | 343.62 | 344.38 | 341.37 |
| Significance (P < 0.05) | ab | bc | a | a | ab |
| Body Weight Coefficient of Variation (Day 14) | 10.35 | 10.15 | 10.96 | 10.50 | 10.91 |
| Significance (P < 0.05) | ab | a | bc | abc | bc |
| Feed Intake (g) Day 0-14 | 18318 | 18236 | 18475 | 18488 | 18365 |
| Significance (P < 0.05) | a | a | a | a | a |

| Days 0-21 | T1 | T2 | T3 | T4 | T5 |
|---|---|---|---|---|---|
| Average Body Wt. (g) Day 21 | 831.77 | 793.42 | 800.57 | 808.42 | 816.92 |
| Significance (P < 0.05) | a | d | cd | bc | ab |
| Feed Conversion Corrected Day 0-21 | 1.28 | 1.33 | 1.32 | 1.32 | 1.30 |
| Significance (P < 0.05) | a | c | bc | bc | abc |
| Mortality % Day 0-21 | 1.50 | 4.91 | 3.85 | 3.21 | 2.78 |
| Significance (P < 0.05) | ab | e | de | bcde | abcd |
| Average Body Wt. Gain (g) Day 0-21 | 789.84 | 751.62 | 758.56 | 766.24 | 775.16 |
| Significance (P < 0.05) | a | c | c | bc | ab |
| Body Weight Coefficient of Variation (Day 21) | 13.59 | 14.53 | 14.52 | 14.27 | 14.36 |
| Significance (P < 0.05) | a | bc | bc | abc | abc |
| Feed Intake (g) Day 0-21 | 52158 | 50203 | 50576 | 51256 | 51573 |
| Significance (P < 0.05) | a | b | ab | ab | ab |
| Days 0-21 | T6 | T7 | T8 | T9 | T10 |
| Average Body Wt. (g) Day 21 | 817.13 | 806.40 | 823.38 | 829.04 | 819.95 |
| Significance (P < 0.05) | ab | bcd | a | a | ab |
| Feed Conversion Corrected Day 0-21 | 1.30 | 1.32 | 1.29 | 1.29 | 1.30 |
| Significance (P < 0.05) | abc | bc | ab | ab | ab |
| Mortality % Day 0-21 | 2.56 | 3.42 | 1.92 | 1.28 | 2.14 |
| Significance (P < 0.05) | abcd | cde | abc | a | abcd |
| Average Body Wt. Gain (g) Day 0-21 | 775.32 | 764.59 | 781.57 | 787.17 | 777.78 |
| Significance (P < 0.05) | ab | bc | a | a | ab |
| Body Weight Coefficient of Variation (Day 21) | 14.42 | 14.72 | 13.83 | 14.45 | 14.09 |
| Significance (P < 0.05) | bc | c | ab | bc | abc |
| Feed Intake (g) Day 0-21 | 51499 | 51150 | 51911 | 52224 | 51599 |
| Significance (P < 0.05) | ab | ab | ab | a | ab |

| Days 0-35 | T1 | T2 | T3 | T4 | T5 |
|---|---|---|---|---|---|
| Average Body Wt. (g) Day 35 | 1926.860 | 1827.598 | 1850.144 | 1865.543 | 1891.042 |
| Significance (P < 0.05) | a | e | de | cd | abc |
| Feed Conversion Corrected Day 0-35 | 1.639 | 1.714 | 1.693 | 1.686 | 1.666 |
| Significance (P < 0.05) | a | d | cd | bcd | abc |
| Mortality % Day 0-35 | 1.932 | 6.280 | 5.072 | 4.348 | 3.623 |
| Significance (P < 0.05) | a | d | cd | bc | abc |
| Average Body Wt. Gain (g) Day 0-35 | 1884.929 | 1785.804 | 1808.129 | 1823.364 | 1849.281 |
| Significance (P < 0.05) | a | e | de | cd | abc |
| Body Weight Coefficient of Variation (Day 35) | 11.529 | 12.896 | 12.767 | 12.429 | 12.670 |
| Significance (P < 0.05) | a | b | b | ab | b |
| Feed Intake (g) Day 0-35 | 147571 | 141148 | 142648 | 144333 | 145558 |
| Significance (P < 0.05) | a | b | ab | ab | ab |
| Days 0-35 | T6 | T7 | T8 | T9 | T10 |
| Average Body Wt. (g) Day 35 | 1888.158 | 1862.322 | 1905.514 | 1915.651 | 1897.583 |
| Significance (P < 0.05) | bc | cde | ab | ab | abc |
| Feed Conversion Corrected Day 0-35 | 1.667 | 1.686 | 1.654 | 1.647 | 1.662 |
| Significance (P < 0.05) | abc | bcd | abc | ab | abc |
| Mortality % Day 0-35 | 3.865 | 4.106 | 2.657 | 1.932 | 2.899 |
| Significance (P < 0.05) | bc | bc | ab | a | ab |
| Average Body Wt. Gain (g) Day 0-35 | 1846.357 | 1820.507 | 1863.708 | 1873.775 | 1855.412 |
| Significance (P < 0.05) | bc | cde | ab | ab | abc |
| Body Weight Coefficient of Variation (Day 35) | 12.298 | 12.418 | 12.003 | 12.068 | 12.419 |
| Significance (P < 0.05) | ab | ab | ab | ab | ab |
| Feed Intake (g) Day 0-35 | 144711 | 144080 | 147021 | 147890 | 146868 |
| Significance (P < 0.05) | ab | ab | a | a | a |

| Days 0-42 | T1 | T2 | T3 | T4 | T5 |
|---|---|---|---|---|---|
| Average Body Wt. (g) Day 42 | 2484.767 | 2362.240 | 2384.678 | 2402.050 | 2436.342 |
| Significance (P < 0.05) | a | d | d | cd | bc |
| Feed Conversion Corrected Day CM2 | 1.761 | 1.840 | 1.823 | 1.811 | 1.792 |
| Significance (P < 0.05) | a | d | cd | bcd | abc |
| Mortality % Day CM2 | 1.932 | 6.763 | 5.556 | 4.589 | 3.865 |
| Significance (P < 0.05) | a | e | de | cd | bcd |
| Average Body Wt. Gain (g) Day 0-42 | 2442.836 | 2320.445 | 2342.663 | 2359.871 | 2394.580 |
| Significance (P < 0.05) | a | d | d | cd | bc |
| Body Weight Coefficient of Variation (Day 42) | 13.118 | 13.621 | 14.004 | 13.568 | 13.524 |
| Significance (P < 0.05) | a | a | a | a | a |
| Feed Intake (g) Day 0-42 | 202810 | 193852 | 196062 | 197597 | 199747 |
| Significance (P < 0.05) | a | c | bc | abc | abc |
| Days 0-42 | T6 | T7 | T8 | T9 | T10 |
| Average Body Wt. (g) Day 42 | 2436.583 | 2402.974 | 2457.695 | 2475.354 | 2451.247 |
| Significance (P < 0.05) | bc | cd | ab | ab | ab |
| Feed Conversion Corrected Day CM2 | 1.791 | 1.814 | 1.776 | 1.768 | 1.786 |
| Significance (P < 0.05) | abc | bcd | ab | a | abc |
| Mortality % Day CM2 | 3.865 | 4.589 | 2.657 | 2.174 | 3.140 |
| Significance (P < 0.05) | bcd | cd | ab | ab | abc |
| Average Body Wt. Gain (g) Day 0-42 | 2394.782 | 2361.159 | 2415.889 | 2433.478 | 2409.076 |
| Significance (P < 0.05) | bc | cd | ab | ab | ab |
| Body Weight Coefficient of Variation (Day 42) | 13.436 | 13.780 | 13.062 | 13.554 | 13.582 |
| Significance (P < 0.05) | a | a | a | a | a |
| Feed Intake (g) Day 0-42 | 198890 | 198244 | 201666 | 203513 | 202059 |
| Significance (P < 0.05) | abc | abc | ab | a | ab |

| Days 15-21 | T1 | T2 | T3 | T4 | T5 |
|---|---|---|---|---|---|
| Feed Conversion Corrected Day 15-21 | 1.395 | 1.427 | 1.416 | 1.423 | 1.410 |
| Significance (P < 0.05) | a | a | a | a | a |
| Mortality % Day 15-21 | 0.427 | 0.641 | 0.855 | 0.641 | 0.855 |
| Significance (P < 0.05) | a | a | a | a | a |
| Average Body Wt. Gain (g) Day 15-21 | 443.450 | 420.564 | 425.557 | 429.680 | 434.862 |
| Significance (P < 0.05) | a | c | bc | abc | abc |
| Feed Intake (g) Day 15-21 | 31746 | 29791 | 30164 | 30845 | 31161 |
| Significance (P < 0.05) | a | b | ab | ab | ab |
| Days 15-21 | T6 | T7 | T8 | T9 | T10 |
| Feed Conversion Corrected Day 15-21 | 1.407 | 1.422 | 1.406 | 1.398 | 1.402 |
| Significance (P < 0.05) | a | a | a | a | a |
| Mortality % Day 15-21 | 0.641 | 1.068 | 0.641 | 0.214 | 0.427 |
| Significance (P < 0.05) | a | a | a | a | a |
| Average Body Wt. Gain (g) Day 15-21 | 435.257 | 428.381 | 437.954 | 442.784 | 436.413 |
| Significance (P < 0.05) | abc | abc | ab | a | abc |
| Feed Intake (g) Day 15-21 | 31088 | 30738 | 31499 | 31812 | 31187 |
| Significance (P < 0.05) | ab | ab | ab | a | ab |

| Days 22-35 | T1 | T2 | T3 | T4 | T5 |
|---|---|---|---|---|---|
| Feed Conversion Corrected Day 22-35 | 1.794 | 1.840 | 1.820 | 1.826 | 1.810 |
| Significance (P < 0.05) | a | a | a | a | a |
| Mortality % Day 22-35 | 0.437 | 1.366 | 1.226 | 1.143 | 0.845 |
| Significance (P < 0.05) | a | a | a | a | a |
| Average Body Wt. Gain (g) Day 22-35 | 1095.093 | 1034.183 | 1049.571 | 1057.120 | 1074.124 |
| Significance (P < 0.05) | a | c | bc | abc | ab |
| Feed Intake (g) Day 22-35 | 88604 | 82181 | 83681 | 85366 | 86591 |
| Significance (P < 0.05) | a | b | ab | ab | ab |
| Days 22-35 | T6 | T7 | T8 | T9 | T10 |
| Feed Conversion Corrected Day 22-35 | 1.815 | 1.826 | 1.806 | 1.805 | 1.812 |
| Significance (P < 0.05) | a | a | a | a | a |
| Mortality % Day 22-35 | 1.301 | 0.687 | 0.734 | 0.650 | 0.762 |
| Significance (P < 0.05) | a | a | a | a | a |
| Average Body Wt. Gain (g) Day 22-35 | 1071.033 | 1055.921 | 1082.135 | 1086.609 | 1077.629 |
| Significance (P < 0.05) | abc | abc | ab | ab | ab |
| Feed Intake (g) Day 22-35 | 85744 | 85113 | 88054 | 88923 | 87901 |
| Significance (P < 0.05) | ab | ab | a | a | a |

| Days 36-42 | T1 | T2 | T3 | T4 | T5 |
|---|---|---|---|---|---|
| Feed Conversion Corrected Day 36-42 | 2.226 | 2.297 | 2.295 | 2.290 | 2.247 |
| Significance (P < 0.05) | a | a | a | a | a |
| Mortality % Day 36-42 | 0.000 | 0.483 | 0.483 | 0.242 | 0.242 |
| Significance (P < 0.05) | a | a | a | a | a |
| Average Body Wt. Gain (g) Day 36-42 | 557.907 | 534.642 | 534.534 | 536.507 | 545.300 |
| Significance (P < 0.05) | a | a | a | a | a |
| Feed Intake (g) Day 36-42 | 55239 | 52704 | 53414 | 53264 | 54189 |
| Significance (P < 0.05) | a | a | a | a | a |
| Days 36-42 | T6 | T7 | T8 | T9 | T10 |
| Feed Conversion Corrected Day 36-42 | 2.246 | 2.276 | 2.213 | 2.197 | 2.244 |
| Significance (P < 0.05) | a | a | a | a | a |
| Mortality % Day 36-42 | 0.000 | 0.483 | 0.000 | 0.242 | 0.242 |
| Significance (P < 0.05) | a | a | a | a | a |
| Average Body Wt. Gain (g) Day 36-42 | 548.425 | 540.652 | 552.181 | 559.703 | 553.664 |
| Significance (P < 0.05) | a | a | a | a | a |
| Feed Intake (g) Day 36-42 | 54180 | 54163 | 54645 | 55623 | 55191 |
| Significance (P < 0.05) | a | a | a | a | a |

| Lesion Scores & Oocysts | T1 | T2 | T3 | T4 | T5 | T6 | T7 | T8 | T9 | T10 |
|---|---|---|---|---|---|---|---|---|---|---|
| Lesion Scores Day 21 | 0.204 | 1.667 | 1.407 | 1.278 | 1.019 | 1.037 | 1.333 | 0.778 | 0.667 | 0.796 |
| Significance (P < 0.05) | a | e | de | cd | bc | bcd | cde | b | b | b |
| Lesion Scores Day 42 | 0.178 | 1.233 | 1.022 | 0.844 | 0.656 | 0.722 | 0.889 | 0.556 | 0.456 | 0.644 |
| Significance (P < 0.05) | a | f | ef | de | bcd | cd | de | bc | b | bcd |
| Coccidial Oocysts (log10) Day 21 | 4.820 | 5.423 | 5.294 | 5.243 | 5.125 | 5.138 | 5.286 | 5.046 | 5.116 | 5.042 |
| Significance (P < 0.05) | a | d | cd | bcd | bc | bc | bcd | abc | bc | ab |
| Coccidial Oocysts (log10) Day 42 | 3.896 | 4.352 | 4.354 | 4.356 | 4.359 | 4.190 | 4.296 | 3.991 | 3.965 | 4.115 |
| Significance (P < 0.05) | a | d | d | d | d | cd | d | ab | ab | bc |

| Intestinal Bacteria Day 21 | T1 | T2 | T3 | T4 | T5 | T6 | T7 | T8 | T9 | T10 |
|---|---|---|---|---|---|---|---|---|---|---|
| Caecal Salmonella Incidence (%) Day 21 | 7.407 | 72.222 | 75.926 | 62.963 | 59.259 | 51.852 | 59.259 | 40.741 | 33.333 | 53.704 |
| Significance (P < 0.05) | a | e | e | de | de | cd | de | bc | b | cd |
| Caecal APC (log10) Day 21 | 8.303 | 10.821 | 10.139 | 9.872 | 9.344 | 9.115 | 9.385 | 8.919 | 8.886 | 9.131 |
| Significance (P < 0.05) | a | e | de | cd | bc | b | bc | ab | ab | bc |
| Caecal E. coli (log10) Day 21 | 6.036 | 8.912 | 8.037 | 7.706 | 7.269 | 7.054 | 7.255 | 7.109 | 6.837 | 7.194 |
| Significance (P < 0.05) | a | e | d | cd | bc | bc | bc | bc | b | bc |
| Caecal Clostridium (log10) Day 21 | 3.522 | 4.560 | 4.404 | 4.307 | 4.216 | 4.121 | 4.390 | 4.004 | 3.701 | 4.255 |
| Significance (P < 0.05) | a | e | de | cde | cd | cd | de | bc | ab | cde |
| Caecal Campylobacter (log10) Day 21 | 3.400 | 4.455 | 4.281 | 4.281 | 4.168 | 4.023 | 4.340 | 3.696 | 3.636 | 3.967 |
| Significance (P < 0.05) | a | 9 | efg | efg | def | de | fg | bc | ab | cd |
| Small Intestine Salmonella Incidence (%) Day 21 | 7.407 | 72.222 | 75.926 | 62.963 | 59.259 | 51.852 | 59.259 | 40.741 | 33.333 | 53.704 |
| Significance (P < 0.05) | a | e | e | de | de | cd | de | bc | b | cd |
| Small Intestine APC (log10) Day 21 | 8.289 | 10.827 | 10.116 | 9.907 | 9.337 | 9.063 | 9.310 | 8.899 | 8.907 | 9.166 |
| Significance (P < 0.05) | a | e | de | cd | bc | b | bc | ab | ab | b |
| Small Intestine E. coli (log10) Day 21 | 6.057 | 8.875 | 8.110 | 7.603 | 7.320 | 7.127 | 7.195 | 7.166 | 6.808 | 7.189 |
| Significance (P < 0.05) | a | e | de | cd | bc | bc | bc | bc | ab | bc |
| Small Intestine Clostridium (log10) Day 21 | 3.595 | 4.519 | 4.398 | 4.312 | 4.209 | 4.136 | 4.388 | 3.954 | 3.683 | 4.362 |
| Significance (P < 0.05) | a | e | de | de | cde | cd | de | bc | ab | de |
| Small Intestine Campylobacter (log10) Day 21 | 3.343 | 4.489 | 4.390 | 4.425 | 4.243 | 4.074 | 4.414 | 3.834 | 3.576 | 3.956 |
| Significance (P < 0.05) | a | e | e | e | de | cd | e | bc | ab | c |

| Intestinal Bacteria Day 42 | T1 | T2 | T3 | T4 | T5 | T6 | T7 | T8 | T9 | T10 |
|---|---|---|---|---|---|---|---|---|---|---|
| Caecal Salmonella Incidence (%) Day 42 | 10.000 | 78.889 | 80.000 | 75.556 | 56.667 | 71.111 | 75.556 | 41.111 | 28.889 | 48.889 |
| Significance (P < 0.05) | a | f | f | f | de | ef | f | bc | b | cd |
| Caecal APC (log10) Day 42 | 8.231 | 10.679 | 10.098 | 9.505 | 9.750 | 9.370 | 9.647 | 8.946 | 9.322 | 9.407 |
| Significance (P < 0.05) | a | e | d | bc | cd | bc | cd | b | bc | bc |
| Caecal E. coli (log10) Day 42 | 6.201 | 8.556 | 8.026 | 7.528 | 7.704 | 7.254 | 7.508 | 6.835 | 7.350 | 7.431 |
| Significance (P < 0.05) | a | e | de | cd | cd | bc | cd | b | bc | c |
| Caecal Clostridium (log10) Day 42 | 3.480 | 4.485 | 4.283 | 4.254 | 4.277 | 4.059 | 4.165 | 3.975 | 3.678 | 4.042 |
| Significance (P < 0.05) | a | e | de | cde | de | bcd | bcd | b | a | bc |
| Caecal Campylobacter (log10) Day 42 | 3.330 | 4.243 | 4.343 | 4.096 | 3.940 | 3.950 | 4.055 | 3.778 | 3.521 | 3.930 |
| Significance (P < 0.05) | a | de | e | cd | bc | bc | cd | b | a | bc |
| Small Intestine Salmonella Incidence (%) Day 42 | 10.000 | 78.889 | 80.000 | 75.556 | 56.667 | 71.111 | 75.556 | 41.111 | 28.889 | 48.889 |
| Significance (P < 0.05) | a | f | f | f | de | ef | f | bc | b | cd |
| Small Intestine APC (log10) Day 42 | 8.248 | 10.705 | 10.131 | 9.499 | 9.807 | 9.393 | 9.663 | 8.985 | 9.316 | 9.420 |
| Significance (P < 0.05) | a | e | d | bc | cd | bc | cd | b | bc | bc |
| Small Intestine E. coli (log10) Day 42 | 6.200 | 8.598 | 8.044 | 7.507 | 7.789 | 7.254 | 7.558 | 6.840 | 7.356 | 7.472 |
| Significance (P < 0.05) | a | e | de | cd | cd | bc | cd | b | bc | cd |
| Small Intestine Clostridium (log10) Day 42 | 3.526 | 4.534 | 4.354 | 4.256 | 4.200 | 4.074 | 4.168 | 3.973 | 3.733 | 4.035 |
| Significance (P < 0.05) | a | e | de | cd | bcd | bc | bcd | b | a | bc |
| Small Intestine Campylobacter (log10) Day 42 | 3.339 | 4.276 | 4.384 | 4.106 | 3.930 | 3.957 | 4.088 | 3.829 | 3.531 | 4.002 |
| Significance (P < 0.05) | a | de | e | cd | bc | bc | cd | b | a | bc |

| Processing Data Day 45 | T1 | T2 | T3 | T4 | T5 | T6 | T7 | T8 | T9 | T10 |
|---|---|---|---|---|---|---|---|---|---|---|
| Breast Salmonella Incidence (%) Day 45 | 1.111 | 25.556 | 11.111 | 21.111 | 13.333 | 18.889 | 15.556 | 10.000 | 7.778 | 6.667 |
| Significance (P < 0.05) | a | e | bc | de | bcd | cde | bcd | abc | ab | ab |
| Breast Clostridium (log10) Day 45 | 1.984 | 3.200 | 3.208 | 2.870 | 2.979 | 2.660 | 2.683 | 2.599 | 2.724 | 2.937 |
| Significance (P < 0.05) | a | c | c | bc | bc | b | b | b | b | bc |
| Breast Campylobacter (log10) Day 45 | 1.482 | 2.850 | 2.881 | 2.759 | 2.496 | 2.655 | 2.482 | 2.094 | 1.920 | 2.753 |
| Significance (P < 0.05) | a | d | d | d | cd | d | cd | bc | ab | d |
| Neck Skin Salmonella Incidence (%) Day 45 | 2.222 | 24.444 | 11.111 | 22.222 | 13.333 | 20.000 | 15.556 | 10.000 | 11.111 | 7.778 |
| Significance (P < 0.05) | a | e | abc | de | bcd | cde | bcde | abc | abc | ab |
| Neck Skin Clostridium (log10) Day 45 | 2.006 | 3.179 | 3.204 | 2.901 | 2.967 | 2.690 | 2.711 | 2.580 | 2.672 | 2.979 |
| Significance (P < 0.05) | a | c | c | bc | bc | b | b | b | b | bc |
| Neck Skin Campylobacter (log10) Day 45 | 1.555 | 2.880 | 2.891 | 2.772 | 2.590 | 2.680 | 2.537 | 2.165 | 1.975 | 2.776 |
| Significance (P < 0.05) | a | d | d | d | cd | d | cd | bc | ab | d |
| Wing Skin Salmonella Incidence (%) Day 45 | 3.333 | 24.444 | 11.111 | 22.222 | 15.556 | 20.000 | 16.667 | 12.222 | 11.111 | 7.778 |
| Significance (P < 0.05) | a | e | abc | de | bcde | cde | bcde | abcd | abc | ab |
| Wing Skin Clostridium (log10) Day 45 | 2.068 | 3.170 | 3.173 | 2.880 | 3.007 | 2.697 | 2.694 | 2.610 | 2.756 | 2.937 |
| Significance (P < 0.05) | a | d | d | bcd | cd | bc | bc | b | bc | bcd |
| Wing Skin Campylobacter (log10) Day 45 | 1.588 | 2.899 | 2.875 | 2.787 | 2.523 | 2.704 | 2.534 | 2.175 | 2.011 | 2.730 |
| Significance (P < 0.05) | a | d | d | d | cd | d | cd | bc | ab | d |

NOTE:
“Significance P < 0.05)” refers to means within a row without a common superscript are significantly different (P < 0.05) as determinedby Least Significant Difference.

| Days 0-14 | T1 | T2 | T3 | T4 | T5 |
|---|---|---|---|---|---|
| Average Body Wt. (g) Day 0 | 42.88 | 43.12 | 42.92 | 43.25 | 43.19 |
| Significance (P < 0.05) | a | a | a | a | a |
| Average Body Wt. (g) Day 14 | 385.37 | 363.45 | 367.14 | 372.08 | 376.88 |
| Significance (P < 0.05) | a | f | ef | cde | bcd |
| Feed Conversion Corrected Day 0-14 | 1.03 | 1.09 | 1.08 | 1.07 | 1.05 |
| Significance (P < 0.05) | a | d | cd | bcd | abc |
| Mortality % Day 0-14 | 1.28 | 5.34 | 4.06 | 3.21 | 2.56 |
| Significance (P < 0.05) | a | d | cd | bc | ab |
| Average Body Wt. Gain (g) Day 0-14 | 342.49 | 320.33 | 324.22 | 328.83 | 333.69 |
| Significance (P < 0.05) | a | e | de | cd | bc |
| Body Weight Coefficient of Variation (Day 14) | 10.36 | 10.64 | 10.68 | 10.31 | 10.83 |
| Significance (P < 0.05) | a | a | a | a | a |
| Feed Intake (g) Day 0-14 | 18248 | 17505 | 17647 | 17874 | 17982 |
| Significance (P < 0.05) | a | b | ab | ab | ab |
| Days 0-14 | T6 | T7 | T8 | T9 | T10 |
| Average Body Wt. (g) Day 0 | 43.02 | 43.00 | 42.79 | 43.32 | 42.99 |
| Significance (P < 0.05) | a | a | a | a | a |
| Average Body Wt. (g) Day 14 | 377.89 | 371.29 | 380.80 | 383.01 | 378.50 |
| Significance (P < 0.05) | bc | de | ab | ab | bc |
| Feed Conversion Corrected Day 0-14 | 1.06 | 1.07 | 1.04 | 1.04 | 1.05 |
| Significance (P < 0.05) | abc | bcd | ab | a | ab |
| Mortality % Day 0-14 | 2.35 | 2.99 | 1.92 | 1.28 | 1.92 |
| Significance (P < 0.05) | ab | bc | ab | a | ab |
| Average Body Wt. Gain (g) Day 0-14 | 334.87 | 328.29 | 338.01 | 339.68 | 335.51 |
| Significance (P < 0.05) | bc | cd | ab | ab | b |
| Body Weight Coefficient of Variation (Day 14) | 10.26 | 10.82 | 10.21 | 10.58 | 10.75 |
| Significance (P < 0.05) | a | a | a | a | a |
| Feed Intake (g) Day 0-14 | 18127 | 17890 | 18119 | 18176 | 18037 |
| Significance (P < 0.05) | a | ab | ab | a | ab |

| Days 0-21 | T1 | T2 | T3 | T4 | T5 |
|---|---|---|---|---|---|
| Average Body Wt. (g) Day 21 | 818.49 | 756.87 | 764.83 | 778.73 | 795.44 |
| Significance (P < 0.05) | a | f | ef | de | c |
| Feed Conversion Corrected Day 0-21 | 1.25 | 1.33 | 1.32 | 1.30 | 1.28 |
| Significance (P < 0.05) | a | d | d | cd | abc |
| Mortality % Day 0-21 | 1.71 | 7.48 | 5.77 | 4.49 | 3.63 |
| Significance (P < 0.05) | a | e | d | cd | bc |
| Average Body Wt. Gain (g) Day 0-21 | 775.61 | 713.76 | 721.91 | 735.48 | 752.25 |
| Significance (P < 0.05) | a | 9 | fg | ef | cd |
| Body Weight Coefficient of Variation (Day 21) | 14.28 | 15.97 | 15.26 | 15.01 | 15.08 |
| Significance (P < 0.05) | abc | e | de | bcd | cde |
| Feed Intake (g) Day 0-21 | 49701 | 46959 | 47367 | 48342 | 48726 |
| Significance (P < 0.05) | a | c | bc | abc | ab |
| Days 0-21 | T6 | T7 | T8 | T9 | T10 |
| Average Body Wt. (g) Day 21 | 794.27 | 779.46 | 805.98 | 812.15 | 799.48 |
| Significance (P < 0.05) | cd | de | abc | ab | bc |
| Feed Conversion Corrected Day 0-21 | 1.28 | 1.30 | 1.26 | 1.25 | 1.27 |
| Significance (P < 0.05) | abc | bcd | a | a | ab |
| Mortality % Day 0-21 | 3.42 | 4.27 | 2.56 | 1.71 | 2.78 |
| Significance (P < 0.05) | bc | c | ab | a | ab |
| Average Body Wt. Gain (g) Day 0-21 | 751.25 | 736.47 | 763.19 | 768.83 | 756.49 |
| Significance (P < 0.05) | cde | def | abc | ab | bc |
| Body Weight Coefficient of Variation (Day 21) | 14.56 | 15.32 | 14.10 | 13.97 | 14.71 |
| Significance (P < 0.05) | abcd | de | ab | a | abcd |
| Feed Intake (g) Day 0-21 | 48844 | 48570 | 49215 | 49533 | 49015 |
| Significance (P < 0.05) | ab | abc | a | a | ab |

| Days 0-35 | T1 | T2 | T3 | T4 | T5 |
|---|---|---|---|---|---|
| Average Body Wt. (g) Day 35 | 1941.558 | 1787.364 | 1809.321 | 1840.568 | 1884.889 |
| Significance (P < 0.05) | a | e | de | d | c |
| Feed Conversion Corrected Day 0-35 | 1.634 | 1.754 | 1.732 | 1.715 | 1.681 |
| Significance (P < 0.05) | a | e | de | cde | bc |
| Mortality % Day 0-35 | 2.174 | 9.179 | 7.005 | 5.556 | 4.348 |
| Significance (P < 0.05) | a | e | d | cd | bc |
| Average Body Wt. Gain (g) Day 0-35 | 1898.677 | 1744.248 | 1766.398 | 1797.322 | 1841.695 |
| Significance (P < 0.05) | a | e | de | d | c |
| Body Weight Coefficient of Variation (Day 35) | 11.297 | 12.392 | 12.574 | 12.401 | 11.933 |
| Significance (P < 0.05) | a | b | b | b | ab |
| Feed Intake (g) Day 0-35 | 147801 | 137745 | 139767 | 142530 | 144959 |
| Significance (P < 0.05) | a | d | cd | bcd | abc |
| Days 0-35 | T6 | T7 | T8 | T9 | T10 |
| Average Body Wt. (g) Day 35 | 1881.766 | 1841.616 | 1912.406 | 1927.171 | 1892.400 |
| Significance (P < 0.05) | c | d | abc | ab | bc |
| Feed Conversion Corrected Day 0-35 | 1.680 | 1.711 | 1.658 | 1.644 | 1.666 |
| Significance (P < 0.05) | bc | cd | ab | ab | ab |
| Mortality % Day 0-35 | 4.106 | 5.314 | 3.140 | 2.415 | 3.623 |
| Significance (P < 0.05) | bc | c | ab | a | ab |
| Average Body Wt. Gain (g) Day 0-35 | 1838.743 | 1798.618 | 1869.615 | 1883.849 | 1849.409 |
| Significance (P < 0.05) | c | d | abc | ab | bc |
| Body Weight Coefficient of Variation (Day 35) | 11.813 | 12.109 | 11.769 | 12.040 | 12.067 |
| Significance (P < 0.05) | ab | ab | ab | ab | ab |
| Feed Intake (g) Day 0-35 | 144770 | 142986 | 146539 | 148063 | 144907 |
| Significance (P < 0.05) | abc | abc | ab | a | abc |

| Days 0-42 | T1 | T2 | T3 | T4 | T5 |
|---|---|---|---|---|---|
| Average Body Wt. (g) Day 42 | 2499.686 | 2297.209 | 2330.995 | 2375.700 | 2422.914 |
| Significance (P < 0.05) | a | e | e | d | c |
| Feed Conversion Corrected Day 0-42 | 1.782 | 1.913 | 1.889 | 1.868 | 1.831 |
| Significance (P < 0.05) | a | e | de | cd | bc |
| Mortality % Day 0-42 | 2.174 | 9.662 | 7.488 | 5.797 | 4.348 |
| Significance (P < 0.05) | a | f | e | d | cd |
| Average Body Wt. Gain (g) Day 0-42 | 2456.805 | 2254.094 | 2288.072 | 2332.454 | 2379.720 |
| Significance (P < 0.05) | a | e | e | d | c |
| Body Weight Coefficient of Variation (Day 42) | 13.080 | 14.238 | 13.613 | 13.401 | 13.825 |
| Significance (P < 0.05) | bc | e | cde | bcd | de |
| Feed Intake (g) Day 0-42 | 205959 | 190792 | 194529 | 198749 | 201234 |
| Significance (P < 0.05) | ab | d | cd | bc | abc |
| Days 0-42 | T6 | T7 | T8 | T9 | T10 |
| Average Body Wt. (g) Day 42 | 2422.228 | 2375.662 | 2461.680 | 2482.201 | 2440.941 |
| Significance (P < 0.05) | c | d | abc | ab | bc |
| Feed Conversion Corrected Day 0-42 | 1.828 | 1.870 | 1.807 | 1.794 | 1.819 |
| Significance (P < 0.05) | bc | cde | ab | ab | ab |
| Mortality % Day 0-42 | 4.589 | 5.556 | 3.382 | 2.415 | 3.865 |
| Significance (P < 0.05) | cd | d | abc | ab | bc |
| Average Body Wt. Gain (g) Day 0-42 | 2379.204 | 2332.665 | 2418.890 | 2438.879 | 2397.949 |
| Significance (P < 0.05) | c | d | abc | ab | bc |
| Body Weight Coefficient of Variation (Day 42) | 12.999 | 13.514 | 12.734 | 12.284 | 13.219 |
| Significance (P < 0.05) | bc | cd | ab | a | bcd |
| Feed Intake (g) Day 0-42 | 201072 | 199809 | 203887 | 206132 | 202620 |
| Significance (P < 0.05) | abc | abc | ab | a | ab |

| Days 15-21 | T1 | T2 | T3 | T4 | T5 |
|---|---|---|---|---|---|
| Feed Conversion Corrected Day 15-21 | 1.318 | 1.384 | 1.375 | 1.373 | 1.343 |
| Significance (P < 0.05) | a | b | ab | ab | ab |
| Mortality % Day 15-21 | 0.427 | 2.137 | 1.709 | 1.282 | 1.068 |
| Significance (P < 0.05) | a | c | bc | abc | abc |
| Average Body Wt. Gain (g) Day 15-21 | 433.121 | 393.424 | 397.687 | 406.651 | 418.562 |
| Significance (P < 0.05) | a | d | d | cd | abc |
| Feed Intake (g) Day 15-21 | 29289 | 26547 | 26955 | 27930 | 28315 |
| Significance (P < 0.05) | a | c | bc | abc | ab |
| Days 15-21 | T6 | T7 | T8 | T9 | T10 |
| Feed Conversion Corrected Day 15-21 | 1.352 | 1.372 | 1.331 | 1.325 | 1.341 |
| Significance (P < 0.05) | ab | ab | ab | ab | ab |
| Mortality % Day 15-21 | 1.068 | 1.282 | 0.641 | 0.427 | 0.855 |
| Significance (P < 0.05) | abc | abc | ab | a | ab |
| Average Body Wt. Gain (g) Day 15-21 | 416.377 | 408.177 | 425.174 | 429.148 | 420.980 |
| Significance (P < 0.05) | bc | cd | ab | ab | abc |
| Feed Intake (g) Day 15-21 | 28433 | 28158 | 28803 | 29122 | 28604 |
| Significance (P < 0.05) | ab | abc | a | a | ab |

| Days 22-35 | T1 | T2 | T3 | T4 | T5 |
|---|---|---|---|---|---|
| Feed Conversion Corrected Day 22-35 | 1.756 | 1.823 | 1.807 | 1.817 | 1.789 |
| Significance (P < 0.05) | a | a | a | a | a |
| Mortality % Day 22-35 | 0.465 | 1.700 | 1.236 | 1.068 | 0.715 |
| Significance (P < 0.05) | a | b | ab | ab | a |
| Average Body Wt. Gain (g) Day 22-35 | 1123.070 | 1030.491 | 1044.489 | 1061.839 | 1089.445 |
| Significance (P < 0.05) | a | c | c | bc | ab |
| Feed Intake (g) Day 22-35 | 88834 | 78778 | 80800 | 83563 | 85992 |
| Significance (P < 0.05) | a | d | cd | bcd | abc |
| Days 22-35 | T6 | T7 | T8 | T9 | T10 |
| Feed Conversion Corrected Day 22-35 | 1.790 | 1.815 | 1.775 | 1.763 | 1.777 |
| Significance (P < 0.05) | a | a | a | a | a |
| Mortality % Day 22-35 | 0.687 | 1.041 | 0.576 | 0.706 | 0.845 |
| Significance (P < 0.05) | a | ab | a | a | a |
| Average Body Wt. Gain (g) Day 22-35 | 1087.497 | 1062.153 | 1106.429 | 1115.016 | 1092.922 |
| Significance (P < 0.05) | ab | bc | a | a | ab |
| Feed Intake (g) Day 22-35 | 85803 | 84019 | 87572 | 89096 | 85940 |
| Significance (P < 0.05) | abc | abc | ab | a | abc |

| Days 36-42 | T1 | T2 | T3 | T4 | T5 |
|---|---|---|---|---|---|
| Feed Conversion Corrected Day 36-42 | 2.318 | 2.497 | 2.474 | 2.434 | 2.377 |
| Significance (P < 0.05) | a | a | a | a | a |
| Mortality % Day 36-42 | 0.000 | 0.483 | 0.483 | 0.242 | 0.000 |
| Significance (P < 0.05) | a | a | a | a | a |
| Average Body Wt. Gain (g) Day 36-42 | 558.128 | 509.846 | 521.675 | 535.132 | 538.025 |
| Significance (P < 0.05) | a | a | a | a | a |
| Feed Intake (g) Day 36-42 | 58159 | 53047 | 54762 | 56219 | 56275 |
| Significance (P < 0.05) | a | a | a | a | a |
| Days 36-42 | T6 | T7 | T8 | T9 | T10 |
| Feed Conversion Corrected Day 36-42 | 2.380 | 2.449 | 2.351 | 2.324 | 2.362 |
| Significance (P < 0.05) | a | a | a | a | a |
| Mortality % Day 36-42 | 0.483 | 0.242 | 0.242 | 0.000 | 0.242 |
| Significance (P < 0.05) | a | a | a | a | a |
| Average Body Wt. Gain (g) Day 36-42 | 540.462 | 534.046 | 549.275 | 555.030 | 548.541 |
| Significance (P < 0.05) | a | a | a | a | a |
| Feed Intake (g) Day 36-42 | 56303 | 56824 | 57348 | 58069 | 57714 |
| Significance (P < 0.05) | a | a | a | a | a |

| Lesion Scores & Oocysts | T1 | T2 | T3 | T4 | T5 | T6 | T7 | T8 | T9 | T10 |
|---|---|---|---|---|---|---|---|---|---|---|
| Lesion Scores Day 21 | 0.389 | 2.093 | 1.611 | 1.463 | 1.037 | 1.185 | 1.333 | 0.778 | 0.519 | 0.907 |
| Significance (P < 0.05) | a | g | f | ef | cde | cdef | def | abc | ab | bcd |
| Lesion Scores Day 42 | 0.167 | 1.733 | 1.444 | 1.244 | 1.078 | 0.956 | 1.178 | 0.500 | 0.378 | 0.711 |
| Significance (P < 0.05) | a | g | fg | ef | e | de | ef | bc | ab | cd |
| Coccidial Oocysts (log10) Day 21 | 4.925 | 5.497 | 5.410 | 5.317 | 5.215 | 5.222 | 5.379 | 5.124 | 4.923 | 5.191 |
| Significance (P < 0.05) | a | e | de | bcde | bcd | bcd | cde | ab | a | bc |
| Coccidial Oocysts (log10) Day 42 | 4.054 | 4.563 | 4.411 | 4.447 | 4.285 | 4.420 | 4.396 | 4.224 | 4.135 | 4.254 |
| Significance (P < 0.05) | a | e | cde | de | bcd | cde | cde | abc | ab | abcd |

| Intestinal Bacteria Day 21 | T1 | T2 | T3 | T4 | T5 | T6 | T7 | T8 | T9 | T10 |
|---|---|---|---|---|---|---|---|---|---|---|
| Caecal Salmonella Incidence (%) Day 21 | 14.815 | 70.370 | 87.037 | 77.778 | 57.407 | 66.667 | 72.222 | 42.593 | 14.815 | 57.407 |
| Significance (P < 0.05) | a | cde | e | de | bc | cd | cde | b | a | bc |
| Caecal APC (log10) Day 21 | 8.328 | 10.562 | 10.739 | 9.839 | 9.926 | 9.874 | 10.100 | 9.316 | 9.511 | 9.352 |
| Significance (P < 0.05) | a | de | e | bc | bcd | bc | cde | b | bc | b |
| Caecal E. coli (log10) Day 21 | 6.065 | 8.557 | 8.751 | 7.708 | 7.940 | 7.743 | 8.001 | 7.175 | 7.222 | 7.223 |
| Significance (P < 0.05) | a | de | e | bc | cd | bc | cd | b | b | b |
| Caecal Clostridium (log10) Day 21 | 3.677 | 4.705 | 4.453 | 4.403 | 4.399 | 4.513 | 4.471 | 4.020 | 3.784 | 4.219 |
| Significance (P < 0.05) | a | e | de | de | de | de | de | bc | ab | cd |
| Caecal Campylobacter (log10) Day 21 | 3.517 | 4.717 | 4.440 | 4.406 | 4.222 | 4.073 | 4.161 | 3.819 | 3.757 | 4.142 |
| Significance (P < 0.05) | a | f | ef | e | de | cd | de | bc | ab | de |
| Small Intestine Salmonella Incidence (%) Day 21 | 14.815 | 70.370 | 87.037 | 77.778 | 57.407 | 66.667 | 72.222 | 42.593 | 14.815 | 57.407 |
| Significance (P < 0.05) | a | cde | e | de | bc | cd | cde | b | a | bc |
| Small Intestine APC (log10) Day 21 | 8.344 | 10.552 | 10.824 | 9.839 | 9.983 | 9.850 | 10.144 | 9.294 | 9.519 | 9.493 |
| Significance (P < 0.05) | a | de | e | bc | cd | bc | cd | b | bc | bc |
| Small Intestine E. coli (log10) Day 21 | 6.041 | 8.460 | 8.719 | 7.650 | 7.944 | 7.745 | 8.032 | 7.213 | 7.224 | 7.264 |
| Significance (P < 0.05) | a | de | e | bc | bcd | bcd | cde | b | b | b |
| Small Intestine Clostridium (log10) Day 21 | 3.742 | 4.719 | 4.389 | 4.426 | 4.343 | 4.517 | 4.397 | 4.057 | 3.779 | 4.165 |
| Significance (P < 0.05) | a | e | bcde | cde | bcd | de | cde | ab | a | bc |
| Small Intestine Campylobacter (log10) Day 21 | 3.547 | 4.691 | 4.423 | 4.350 | 4.160 | 4.162 | 4.183 | 3.741 | 3.670 | 4.174 |
| Significance (P < 0.05) | a | c | bc | b | b | b | b | a | a | b |

| Intestinal Bacteria Day 42 | T1 | T2 | T3 | T4 | T5 | T6 | T7 | T8 | T9 | T10 |
|---|---|---|---|---|---|---|---|---|---|---|
| Caecal Salmonella Incidence (%) Day 42 | 13.333 | 84.444 | 78.889 | 74.444 | 66.667 | 56.667 | 72.222 | 38.889 | 20.000 | 52.222 |
| Significance (P < 0.05) | a | f | ef | ef | de | cd | ef | b | a | c |
| Caecal APC (log10) Day 42 | 9.079 | 11.088 | 10.585 | 10.465 | 9.779 | 9.658 | 9.785 | 9.517 | 9.792 | 10.013 |
| Significance (P < 0.05) | a | e | de | cd | b | b | b | ab | b | bc |
| Caecal E. coli (log10) Day 42 | 7.050 | 9.108 | 8.371 | 8.386 | 7.795 | 7.507 | 7.663 | 7.369 | 7.712 | 7.774 |
| Significance (P < 0.05) | a | e | cd | d | bc | ab | b | ab | b | b |
| Caecal Clostridium (log10) Day 42 | 3.502 | 4.576 | 4.465 | 4.415 | 4.255 | 4.218 | 4.257 | 4.140 | 3.866 | 4.103 |
| Significance (P < 0.05) | a | f | ef | def | cde | cd | cde | c | b | bc |
| Caecal Campylobacter (log10) Day 42 | 3.574 | 4.371 | 4.427 | 4.339 | 4.356 | 4.046 | 4.220 | 4.044 | 3.699 | 4.147 |
| Significance (P < 0.05) | a | cd | d | cd | cd | b | bcd | b | a | bc |
| Small Intestine Salmonella Incidence (%) Day 42 | 13.333 | 84.444 | 78.889 | 74.444 | 66.667 | 56.667 | 72.222 | 38.889 | 20.000 | 52.222 |
| Significance (P < 0.05) | a | f | ef | ef | de | cd | ef | b | a | c |
| Small Intestine APC (log10) Day 42 | 9.111 | 11.110 | 10.575 | 10.357 | 9.773 | 9.686 | 9.747 | 9.538 | 9.824 | 10.025 |
| Significance (P < 0.05) | a | e | de | cd | b | b | b | ab | bc | bcd |
| Small Intestine E. coli (log10) Day 42 | 6.997 | 9.089 | 8.440 | 8.400 | 7.823 | 7.531 | 7.665 | 7.382 | 7.730 | 7.884 |
| Significance (P < 0.05) | a | e | d | cd | bc | ab | b | ab | b | bcd |
| Small Intestine Clostridium (log10) Day 42 | 3.486 | 4.606 | 4.505 | 4.452 | 4.278 | 4.168 | 4.290 | 4.168 | 3.989 | 4.205 |
| Significance (P < 0.05) | a | f | ef | def | cde | bc | cde | bc | b | bcd |
| Small Intestine Campylobacter (log10) Day 42 | 3.549 | 4.434 | 4.418 | 4.421 | 4.277 | 4.119 | 4.313 | 4.023 | 3.657 | 4.079 |
| Significance (P < 0.05) | a | d | d | d | cd | bc | cd | b | a | bc |

| Processing Data Day 45 | T1 | T2 | T3 | T4 | T5 | T6 | T7 | T8 | T9 | T10 |
|---|---|---|---|---|---|---|---|---|---|---|
| Breast Salmonella Incidence (%) Day 45 | 0.000 | 20.000 | 13.333 | 13.333 | 11.111 | 11.111 | 22.222 | 13.333 | 10.000 | 15.556 |
| Significance (P < 0.05) | a | cd | bcd | bcd | bc | bc | d | bcd | b | bcd |
| Breast Clostridium (log10) Day 45 | 2.038 | 3.391 | 3.088 | 3.068 | 3.085 | 3.066 | 3.005 | 2.605 | 2.448 | 2.958 |
| Significance (P < 0.05) | a | e | de | de | de | de | d | bc | b | cd |
| Breast Campylobacter (log10) Day 45 | 1.646 | 3.175 | 2.879 | 2.806 | 2.437 | 2.809 | 2.600 | 2.337 | 1.857 | 2.324 |
| Significance (P < 0.05) | a | d | c | c | b | c | bc | b | a | b |
| Neck Skin Salmonella Incidence (%) Day 45 | 1.111 | 20.000 | 14.444 | 15.556 | 12.222 | 13.333 | 22.222 | 15.556 | 13.333 | 15.556 |
| Significance (P < 0.05) | a | bc | bc | bc | b | bc | c | bc | bc | bc |
| Neck Skin Clostridium (log10) Day 45 | 2.051 | 3.387 | 3.123 | 3.080 | 3.074 | 3.017 | 3.049 | 2.628 | 2.471 | 2.995 |
| Significance (P < 0.05) | a | e | de | de | de | d | de | bc | b | cd |
| Neck Skin Campylobacter (log10) Day 45 | 1.697 | 3.258 | 2.862 | 2.844 | 2.520 | 2.828 | 2.638 | 2.336 | 1.820 | 2.381 |
| Significance (P < 0.05) | a | e | d | cd | bc | cd | bcd | b | a | b |
| Wing Skin Salmonella Incidence (%) Day 45 | 1.111 | 20.000 | 14.444 | 16.667 | 13.333 | 14.444 | 24.444 | 15.556 | 13.333 | 16.667 |
| Significance (P < 0.05) | a | bc | b | bc | b | b | c | bc | b | bc |
| Wing Skin Clostridium (log10) Day 45 | 2.121 | 3.374 | 3.091 | 3.065 | 3.051 | 3.015 | 2.984 | 2.628 | 2.512 | 3.014 |
| Significance (P < 0.05) | a | e | de | de | de | de | cd | bc | b | de |
| Wing Skin Campylobacter (log10) Day 45 | 1.702 | 3.214 | 2.943 | 2.800 | 2.481 | 2.831 | 2.654 | 2.383 | 1.867 | 2.357 |
| Significance (P < 0.05) | a | e | de | cd | bc | cd | bcd | b | a | b |

NOTE:
“Significance P < 0.05)” refers to means within a row without a common superscript are significantly different (P < 0.05) as determinedby Least Significant Difference.

### Example 2: Pigs Challenged with E. coli

Early weaned piglets (18 days old) were treated in 8 replicates for 21 days. Study animals have been without a therapeutic antimicrobial by any route 8 days prior to challenge and no history of vaccination against the challenge pathogens. Pigs are allowed to be vaccinated against circovirus and M. hyo at weaning.

Pigs are provided feed and water ad libitum throughout the study.

Pigs are fed a creep feed and a nursery feed. “Creep feed” is a feed containing the test article, antibiotic (Avilamycin, 80 ppm) or no test article and is provided as a creep feed from approximately 10 days of age (trial day −8 of study to weaning) until a target weight of 4-5 kg. “Nursery feed” is a feed containing the test article, antibiotic (Avilamycin, 80 ppm) or no test article and is provided from day 0 (weaning) to 21.

On Study Day 5, study pigs from treatment groups 2, 3, and 5 are challenged orally with E. coli challenge according to the following scheme:

| | | Treatment | | Challenge | Challenge |
|---|---|---|---|---|---|
| Treatment | No. of | Administration/ | Treatment | Description/ | Route/ |
| Group | Animals | Study Day | Route | Study Day | Volume |
| T1 | 32 | Creep and Nursery | Oral in | None | not applicable |
| | | diet without | feed | | |
| | | Monobutyrin | | | |
| T2 | 32 | Creep and Nursery | Oral in | Escherichia coli, | Oral, 5 ml |
| | | diet without | feed | ca. 10\hat{ }4cfu/ml, | |
| | | Monobutyrin | | Day 5 | |
| T3 | 32 | Creep and Nursery | Oral in | Escherichia coli, | Oral, 5 ml |
| | | diet with Monobutyrin | feed | ca. 10\hat{ }4 cfu/ml, | |
| | | 3 kg/MT Pre & Post- | | Day 5 | |
| | | wean | | | |
| T4 | 32 | Creep diet without | Oral in | None | not applicable |
| | | Monobutyrin Pre- | feed | | |
| | | wean; Nursery diet | | | |
| | | with Monobutyrin 3 | | | |
| | | kg/MT Post-wean | | | |
| T5 | 32 | Creep and Nursery | Oral in | Escherichia coli, | Oral, 5 ml |
| | | diet with Avilamycin | feed | ca. 10\hat{ }4 cfu/ml, | |
| | | 80 ppm Pre & Post- | | Day 5 | |
| | | wean | | | |

| day | description |
|---|---|
| −8 to 0 | General Health Observations 2x per day; |
| | Duplicate Ear Tags; Creep Feed Issue |
| 0 to 21 | General Health Observations 2x per day; |
| | Necropsy, body weight, & ileum scoring on |
| | any removals; Nursery Feed Issue as required |
| 0 | Randomly assign pigs to Nursery pens; |
| | Body Weight Collection; Fecal Collection |
| | 2 pigs/pen |
| 5 | Body weight collection prior challenge; |
| | Fecal collection, 2 pigs/pen; Clinical and fecal |
| | scoring prior to challenge; E. Coli challenge |
| 5 to 21 | Daily Clinical and Fecal Scoring; |
| 7 | Body Weight Collection; Feed Issue & Weighback; |
| | Fecal Collection 2 pigs/pen |
| 14 | Body Weight Collection; Feed Issue & Weighback; |
| | Fecal collection 2 pigs/pen; |
| | Necropsy & Ileum Scoring of 1 gilt per pen |
| 21 | Body Weight Collection; Feed Issue & Weighback; |
| | Euthanize All Remaining Pigs; |
| | Necropsy & Ileum Scoring on All Remaining Pigs; |
| | Animal Disposition; Feed Disposition |

For all trials, the average body weight at day 0 was approx. 5 kg and the average body weight coefficient of variation was not significantly different (p<0.05).

At day 5, the body weights for treatments T3 and T5 were significantly (p<0.05) higher than for T1 and T2, the average body weight coefficient of variation was not significantly different (p<0.05) for all treatments.

The body weight gain (g per pig and day) in the period of trial days 0-5 was significantly higher for treatments T3, T4 and T5 compared to T1 and T2 (p<0.05). The feed consumption (g per pig and day) and mortality were not significantly different (p<0.05) for all treatments during days 0-5.

On day 14, the average body weight for treatment T2 was significantly (p<0.05) lower (ca. 8 kg) than for all other treatments; the average body weights of treatments T1 and T4 were not significantly (p<0.05) different (ca. 8.8 kg vs. ca. 9.1 kg), the average body weights of treatments T1 and T3 and T5 were not significantly (p<0.05) different (ca. 8.8 kg vs. ca. 8.7 and ca. 8.7 kg). The average body weights of treatments T3 and T5 were significantly (p<0.05) higher than for treatment T2. The average body weight coefficient of variation was not significantly different (p<0.05) for treatments T1, T3, T4 and T5; the average body weight coefficient of variation was significantly higher (p<0.05) for treatment T2 compared to all other treatments.

The body weight gain (g per pig and day) in the period of trial days 0-14 was significantly higher for treatments T1, T3, T4 and T5 compared to T2 (p<0.05) and did not significantly (p<0.05) differ between treatments T1, T3, and T5. The body weight gain (g per pig and day) in the period of trial days 0-14 was significantly higher for treatment T4 compared to all other treatments (p<0.05). The feed consumption (g per pig and day) was not significantly different (p<0.05) for all treatments during days 0-14. Mortality for treatment T2 was significantly higher (p<0.05) compared to all other treatments; no significant difference in mortality was observed between treatments T1, T3, T4 and T5 (p<0.05).

On day 21, the average body weight for treatment T2 was significantly (p<0.05) lower (ca. 14.5 kg) than for all other treatments; the average body weights of treatments T1, T3, T4 and T5 were not significantly (p<0.05) different (ca. 16 kg, ca. 16 kg, ca. 16.2 kg and ca. 16 kg, respectively). The average body weight coefficient of variation was not significantly different (p<0.05) for treatments T1, T3, T4 and T5; the average body weight coefficient of variation was significantly higher (p<0.05) for treatment T2 compared to all other treatments.

The body weight gain (g per pig and day) in the period of trial days 0-21 was significantly higher for treatments T1, T3, T4 and T5 compared to T2 (p<0.05); in the same period, the body weight gain was significantly (p<0.05) higher for treatment T4 compared to treatments T3 and T5 and did not significantly (p<0.05) differ from treatment T1. The feed consumption (g per pig and day) was not significantly different (p<0.05) for all treatments during days 0-21. Mortality for treatment T2 was significantly higher (p<0.05) compared to all other treatments; no significant difference in mortality was observed between treatments T1, T3, T4 and T5 (p<0.05).

### Example 3: Shrimp

This trial was designed to test for the efficacy of feed additives Amasil NA and Monobutyrin supplemented diets which were fed to Penaeus vannamei (Konabay Hawaii broodstock) for 10 days. After 10 days of feeding (pre-challenge), experimental shrimp were subjected to a challenge test with EMS/AHPND causing Vibrio parahaemolyticus and the survival rates were recorded daily up to 10 days.

The feed used in this experiment is a commercial feed “LOTUS shrimp feed” manufactured by CP Foods (Vietnam) and is mixed with Monobutyrin (6 kg/MT and 6 kg/MT), Amasil NA (3 kg/MT) and both Monobutyrin and Amasil NA (each 3 kg/MT) using a cold-extruding method. The feed additives are mixed with the shrimp No. 0 size feed (dust feed, fine particles), and bound with carboxymethyl cellulose (CMC) and moisture before being extruded using a pressurized meat grinder. The extruded mix is then dried at 50° C. for 6 hours. The final moisture of the feed did not exceed 11%. The feed is crumpled to pellets around 1.5-2 mm in length. The finished pellet feeds are stored in plastic containers at 4° C. until use.

One day prior to the start of the study, thirty-five SPF P. vannamei post-larva weighing ˜1.5 g were transferred to 48 120 l tanks containing 90 l of seawater (salinity at 15 ppt). Tanks are continuously aerated to maintain optimal oxygen levels. All aquaria are outfitted with a submerged filter covered with plastic to reduce the risk of cross-contamination. Throughout the experiment, a satiation feeding regimen is adopted for all tanks. All tanks are fed to satiation four times per day.

A virulent strain of Vibrio parahaemolyticus is inoculated in Tryptic Soy Broth +2% sodium chloride (TSB+). Cultures are incubated for 24 hrs at 28° C. at 150 rpm. Bacterial density is measured by optical density absorbance (OD600 nm). Enough volume of bacterial suspension is added directly into the challenge tanks to kill 80-100% shrimp in the positive control within five days.

Shrimp deaths started on the 2nd day post-challenge. The clinical signs included: shrimp off-feeding, empty gut and stomach, pale-atrophied hepatopancreas. Positive control tanks appeared to be infected and suffered a rapid mortality. Peak mortality happened on day 3 post-challenge after which mortal outcomes even out and remained flat for the rest of the challenge. Higher survival percentage is observed for shrimp being fed AMASIL NA or Monobutyrin and highest survival percentage is expected for shrimp being fed both AMASIL NA and Monobutyrin.

Pre-challenge feeding had no significant effect on the mortality of shrimp before the challenge.

1.-16. (canceled)

17. A composition comprising
formic acid or a pharmaceutically acceptable salt thereof,
glycerol and
one or more butyric acid glycerides and optionally butyric acid,
wherein
a) formic acid, glycerol and the one or more butyric acid glycerides are present in synergistic amounts, and/or
b) the weight ratio of glycerol to total butyric acid glycerides is from 1:10 to 10:1, and/or
c) the weight ratio of formic acid to the total of butyric acid glycerides and glycerol is from 1:15 to 20:1, and/or
d) the total amount of the total of formic acid, glycerol and butyric acid glycerides is from 10 wt % to 100 wt % of the total composition.

18. The composition according to claim 17, wherein
a) the concentration of formic acid is 1 to 15 g per kg of the total composition, and/or
b) the concentration of the total of glycerol and butyric acid glycerides is 0.5 to 30 g per kg of the total composition.

19. The composition according to claim 17, wherein
a) the concentration of formic acid is 3 to 8 g per kg of the total composition, and/or
b) the concentration of the total of glycerol and butyric acid glycerides is 0.8 to 20 g per kg of the total composition.

20. The composition according to claim 17, wherein
the composition is a feed composition for poultry, ruminants, pigs, finfish and/or shrimps, finfish, including eggs, fry, juvenile fish and adult fish,
shellfish, including eggs, larvae, juvenile and adult shellfish.

21. The composition according to claim 19, further comprising one or more of:
i) carbohydrates
ii) lipids
iii) proteins
iv) amino acids,
v) salts (other than formic acid salts) and/or minerals,
vi) vitamins,
vii) prebiotics, and
viii) probiotics.

22. The composition according to claim 19, wherein the feed composition is a
a) starter feed composition comprising
formic acid in a concentration of 1-8 g/kg, and
glycerol and butyric acid glyceride
in a weight ratio of 1:10 to 10:1 and/or
in a total concentration of 1-8 g/kg;
b) grower feed composition comprising
formic acid in a concentration of 1-6 g/kg, and
glycerol and butyric acid glyceride
in a weight ratio of 1:10 to 10:1, and/or
in a total concentration of 0.1-6 g/kg;
c) finisher feed composition comprising
formic acid in a concentration of 1-4 g/kg, and
glycerol and butyric acid glyceride
in a weight ratio of 1:10 to 10:1, and/or
in a total concentration of 0.1-4 g/kg.

23. The composition according to claim 19, wherein the feed composition is a
a) starter feed composition comprising
a Na salt of formic acid in a concentration of 1-8 g/kg, and
glycerol and butyric acid glyceride
in a weight ratio of 1:10 to 10:1 and/or
in a total concentration of 1-8 g/kg;
b) grower feed composition comprising
a Na salt of formic acid in a concentration of 1-6 g/kg, and
glycerol and butyric acid glyceride
in a weight ratio of 1:10 to 10:1, and/or
in a total concentration of 0.1-6 g/kg;
c) finisher feed composition comprising
a Na salt of formic acid in a concentration of 1-4 g/kg, and
glycerol and butyric acid glyceride
in a weight ratio of 1:10 to 10:1, and/or
in a total concentration of 0.1-4 g/kg.

24. The composition according to claim 17, wherein the composition is
a solid composition or
a liquid composition.

25. The composition according to claim 17, wherein the composition is
a solid composition which is in the form of a pellet or extrudate or meal, or
a liquid composition comprising 30 to 99.999 wt % water.

26. A treatment or prevention of microbial infections or disorders associated with microbial infections in an animal which comprises the composition according to claim 17.

27. A medicament which comprises the composition according to claim 17.

28. A veterinary formulation comprising an effective amount of
formic acid and/or a pharmaceutically acceptable salt thereof,
glycerol and
one or more butyric acid glycerides and optionally butyric acid.

29. An antimicrobial composition for treating an animal, comprising the composition according to claim 17.

30. Antimicrobial composition for the prevention or treatment of infections by a microorganism selected from the group consisting of
i) alveolates,
ii) microogranisms of order Enterobacterales, Vibrionales, Desulfovibrionales, Pseudomonadales, Burkholderiales or Campylobacterales, and
iii) icroorganisms of order Clostridiales, Bacillales or Lactobacillales in an animal,
comprising the composition according to claim 17.

31. Antimicrobial composition for use in an animal for reducing, compared to an untreated control,
i) the small intestine lesion score,
ii) the small intestine coccidial oocyst count, and/or
iii) in caecum, small intestine, breast meat, wing meat and/or neck skin any of: the incidence of the microorganism according to claim 30, the titre of a microorganism according to claim 30, and the APC.

32. The composition according to claim 17, wherein the composition improves one or more of
body weight gain
body weight coefficient of variation
feed conversion ratio
survivor percentage
feed intake
birth rate
egg quality
hatchability
in an animal.

33. A feeding regime, comprising the steps of administering to an animal
a) a starter feed composition according to claim 22 for a first period of time and, thereafter, a grower feed composition according to claim 22 for a second period of time,
b) a starter feed composition according to claim 22 for a first period of time and, thereafter, a finisher feed composition according to claim 22 for a second period of time,
c) a starter feed composition according to claim 22 for a first period of time and, thereafter, a grower feed composition according to claim 22 for a second period of time and, thereafter, a finisher feed composition according to claim 22 for a third period of time, or
d) a grower feed composition according to claim 22 for a first period of time and, thereafter, a finisher composition according to claim 22 for a second period of time, or
e) a starter feed composition according to claim 22 for a first period of time and optionally, thereafter, a probiotic feed.

34. A feeding regime according to claim 30, wherein the animal is selected from the group consisting of
i) aquatic animals, and
ii) land animals.

35. A feeding regime according to claim 30, wherein the animal is selected from the group consisting of
i) finfish or shellfish, and
ii) livestock, poultry, game or pets.

36. A method for rearing an animal, said method comprising feeding the animal with the composition according to claim 17.
